(19) United States
(12) Patent Application Publication
(10) Pub. No.: US 2012/0201570 A1
(43) Pub. Date: Aug. 9, 2012

(54) ELECTROPHOTOGRAPHIC PHOTOSENSITIVE MEMBER AND ELECTROPHOTOGRAPHIC APPARATUS

(75) Inventors: Shigenori Ueda, Toride-shi (JP); Satoshi Kojima, Yokohama-shi (JP)

(73) Assignee: CANON KABUSHIKI KAISHA, Tokyo (JP)

(21) Appl. No.: 13/501,163

(22) PCT Filed: Dec. 16, 2010
(86) PCT No.: PCT/JP2010/073259

§ 371 Date: Apr. 10, 2012

(30) Foreign Application Priority Data
Dec. 28, 2009 (JP) 2009-298072
Dec. 14, 2010 (JP) 2010-277782

(51) Int. Cl. G03G 15/00

(52) U.S. Cl. 399/159

(57) ABSTRACT

The present invention provides an electrophotographic photosensitive member having an a-SiC upper charge injection inhibition layer and an a-SiC surface layer, which is superior in adhesiveness, suppresses the surface deterioration, is superior in sensitivity characteristics and charging characteristics, and can keep an adequate image-forming capability for a long period of time. The upper charge injection inhibition layer contains 10 atom ppm or more and 30,000 atom ppm or less of the Group 13 atoms or the Group 15 atoms of the Periodic Table with respect to silicon atoms in the upper charge injection inhibition layer, and the ratio (C/(Si+C)) of the number of carbon atoms in the upper charge injection inhibition layer with respect to the sum of the number of silicon atoms and the number of the carbon atoms in the upper charge injection inhibition layer is 0.10 or more and 0.60 or less; and the sum of the atom density of the silicon atoms and the atom density of the carbon atoms in the surface layer is 6.60×10²² atoms/cm³ or more, and the ratio (C/(Si+C)) of the number of carbon atoms with respect to the sum of the number of silicon atoms and the number of the carbon atoms in the surface layer is 0.61 or more and 0.75 or less.

### TECHNICAL FIELD

The present invention relates to an electrophotographic photosensitive member having a surface layer formed from hydrogenated amorphous silicon carbide (hereinafter, referred to as “a-SiC” as well), and an electrophotographic apparatus having the electrophotographic photosensitive member. Hereinafter, the surface layer formed from “a-SiC” is referred to as “an a-SiC surface layer” as well.

### BACKGROUND ART

An electrophotographic photosensitive member is widely known which has a photoconductive layer (a photosensitive layer) formed from an amorphous silicon (hereinafter referred to as “a-Si” as well) on a substrate. Hereinafter, the photoconductive layer formed from a-Si is referred to as “an a-Si photoconductive layer” as well. An a-Si electrophotographic photosensitive member (hereinafter, referred to as “an a-Si photosensitive member” as well) has already been commercialized, which has an a-Si photoconductive layer formed on a conductive substrate such as metal, with a film-forming technology such as CVD and PVD, in particular.

Patent Literature 1 discloses an a-Si photosensitive member that has an upper charge injection inhibition layer provided between a photoconductive layer and a surface layer, which is formed of a non-single-crystal silicon film that contains a carbon atom and a Group 13 element of the Periodic Table while employing a silicon atom as the matrix. By having a layer structure like this, the electrophotographic photosensitive member enhances its capability of inhibiting charge injection from the surface and can obtain adequate charging characteristics. The enhancement of the charging characteristics like this is conspicuously observed in an electrophotographic photosensitive member to be negatively charged in particular.

In addition, an a-SiC surface layer has been mainly used as a surface layer of an a-Si photosensitive member in an electrophotographic apparatus with a fast processing speed because of having a superior abrasion resistance.

However, a conventional a-SiC surface layer occasionally has caused an oxidation of the surface and deterioration when having been subjected to electrophotographic processes repeatedly.

This deterioration phenomenon is suppressed so as not to become obvious because the deteriorated layer is eliminated by a wearing action in a cleaning step in a normally operating environment and a normally use condition.

However, a big change occasionally occurs in an electric current and voltage applied to the electrophotographic photosensitive member or in a product by electrostatic charge, or a cleaning condition may greatly change, due to the deviation of values from the optimum set values for each mechanism in an electrophotographic apparatus or a sudden change in a surrounding environment. When a change like this has occurred, there is the case in which the deteriorated layer remains on the surface of the electrophotographic photosensitive member, as a result of the change.

As thus described, when the deteriorated layer remains, it is rare that the deteriorated layer uniformly remains on the surface of the electrophotographic photosensitive member, and the deteriorated layer remains ununiformly in many cases. This deteriorated layer is formed from silicon oxide as a main component, and accordingly the refractive index becomes a middle value between the refractive index of air and the refractive index of the a-SiC surface layer. As a result, the deteriorated layer works as an anti-reflection coating. Because of this, the reflectance of an image-exposing light which has irradiated the surface of the electrophotographic photosensitive member decreases in a part at which the deteriorated layer remains. Therefore, even if a predetermined light quantity of the image-exposing light has irradiated the electrophotographic photosensitive member uniformly, the light quantity of the image-exposing light which has been incident on the electrophotographic photosensitive member is different between the part at which the deteriorated layer remains and a part at which the deteriorated layer does not exist thereon. Because of this, there has been the case in which sensitivity irregularity is generated and the uniformity of the image is impaired.

Patent Literature 2 discloses a photoreceptive member having a surface layer formed from non-single-crystal hydrogenated carbon, as a technology of suppressing the deterioration of the surface layer.

It is assumed that the oxidation of the surface of the surface layer by ozone which is the product by electrostatic charge can be reduced by employing the non-single-crystal hydrogenated carbon film which does not contain a silicon atom that tends to be easily coupled with an oxygen atom (in other words, to be easily oxidized), as the surface layer.

Citation List

Patent Literature

PTL 1: Japanese Patent No. 3902975

PTL 2: Japanese Patent Application Laid-Open No. 2001-330977

### SUMMARY OF INVENTION

The deterioration of the surface of the surface layer is improved by using the surface layer formed from the non-single-crystal hydrogenated carbon, but when the surface layer formed from non-single-crystal hydrogenated carbon is formed on an upper charge injection inhibition layer formed from a-SiC, there has been the case in which the adhesiveness has become insufficient. This is assumed to occur because the adhesiveness in the boundary between the layers is impaired due to a difference of structures between a-SiC and non-single-crystal hydrogenated carbon and consequently the boundary receives a mechanical stress. The upper charge injection inhibition layer formed from a-SiC is hereinafter referred to as “an a-SiC upper charge injection inhibition layer” as well.

Conventionally, in the electrophotographic photosensitive member having the a-SiC upper charge injection inhibition layer and the a-SiC surface layer, it has been difficult to suppress the surface deterioration over a long period of time and impart adequate adhesiveness between the layers at the same time.

An object of the present invention is to provide an electrophotographic photosensitive member having the a-SiC upper charge injection inhibition layer and the a-SiC surface layer, which is superior in adhesiveness between the layers, has the surface of which the deterioration is suppressed, is superior in sensitivity characteristics and charging characteristics, and can keep an adequate image-forming capability for a long period of time, and to provide an electrophotographic apparatus having the electrophotographic photosensitive member.

The present invention provides an electrophotographic photosensitive member having a conductive substrate, a lower charge injection inhibition layer formed from amorphous silicon on the conductive substrate, a photoconductive layer formed from amorphous silicon on the lower charge injection inhibition layer, an upper charge injection inhibition layer formed from hydrogenated amorphous silicon carbide on the photoconductive layer, and a surface layer formed from hydrogenated amorphous silicon carbide on the upper charge injection inhibition layer, characterized in that the upper charge injection inhibition layer contains 10 atom ppm or more and 30,000 atom ppm or less of the Group 13 atoms or the Group 15 atoms of the Periodic Table with respect to silicon atoms in the upper charge injection inhibition layer, and the ratio (C/(Si+C)) of the number (C) of carbon atoms in the upper charge injection inhibition layer with respect to the sum of the number (Si) of silicon atoms and the number (C) of the carbon atoms in the upper charge injection inhibition layer is 0.10 or more and 0.60 or less; and the sum of the atom density of the silicon atoms and the atom density of the carbon atoms in the surface layer is 6.60×10²² atoms/cm³ or more, and the ratio (C/(Si+C)) of the number (C) of the carbon atoms in the surface layer with respect to the sum of the number (Si) of the silicon atoms and the number (C) of the carbon atoms in the surface layer is 0.61 or more and 0.75 or less.

The present invention also provides an electrophotographic apparatus having the electrophotographic photosensitive member and an charging unit, an image-exposing unit, a developing unit and a transferring unit.

The present invention can provide an electrophotographic photosensitive member having the a-SiC upper charge injection inhibition layer and the a-SiC surface layer, which is superior in adhesiveness between the layers, has the surface of which the deterioration is suppressed, is superior in sensitivity characteristics and charging characteristics, and can keep an adequate image-forming capability for a long period of time, and provide an electrophotographic apparatus having the electrophotographic photosensitive member.

Further features of the present invention will become apparent from the following description of exemplary embodiments with reference to the attached drawings.

### BRIEF DESCRIPTION OF DRAWINGS

FIG. 1 is a view illustrating one example of a layer structure of an electrophotographic photosensitive member according to the present invention.

FIG. 2 is a view illustrating one example of a structure of a plasma CVD deposition apparatus with the use of a high-frequency power with the RF bands, which can be used in the manufacture of an electrophotographic photosensitive member according to the present invention.

FIG. 3 is a view illustrating one example of a structure of an electrophotographic apparatus according to the present invention.

### DESCRIPTION OF EMBODIMENTS

The present inventors, firstly, made an investigation on an a-SiC surface layer (a surface layer formed from hydrogenated amorphous silicon carbide) in order to aim at the realization of the a-SiC surface layer which can suppress the deterioration of the surface, while considering the adhesiveness of the a-SiC surface layer with an a-SiC upper charge injection inhibition layer (an upper charge injection inhibition layer formed from hydrogenated amorphous silicon carbide). As a result, the present inventors have found that the surface deterioration can be suppressed by firstly controlling a ratio (C/(Si+C)) of the number (C) of carbon atoms to the sum (Si+C) of the number (Si) of silicon atoms and the number (C) of the carbon atoms in the a-SiC surface layer to 0.61 or more and 0.75 or less, and besides controlling the sum of the atom density of the silicon atoms and the atom density of the carbon atoms in the a-SiC surface layer to 6.60×10²² atoms/cm³ or more. Hereafter, the atom density of silicon atoms is referred to as “Si atom density” as well, the atom density of carbon atoms is referred to as “C atom density” as well, and the sum of the Si atom density and the C atom density is referred to as “Si+C atom density” as well.

Next, the present inventors examined on the adhesiveness between the a-SiC upper charge injection inhibition layer and the above-described a-SiC surface layer, as a result, confirmed that the sufficient adhesiveness was obtained, and arrived at the completion of the present invention.

<Electrophotographic Photosensitive Member of the Present Invention>

An electrophotographic photosensitive member according to the present invention is the electrophotographic photosensitive member which has a conductive substrate, a lower charge injection inhibition layer formed on the conductive substrate, a photoconductive layer formed on the lower charge injection inhibition layer, an upper charge injection inhibition layer formed on the photoconductive layer, and a surface layer formed on the upper charge injection inhibition layer.

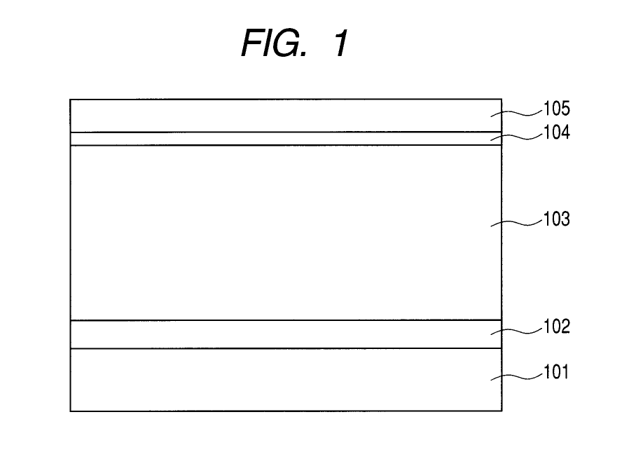

FIG. 1 is a view illustrating one example of a layer structure of the electrophotographic photosensitive member according to the present invention. In FIG. 1, the conductive substrate 101, the lower charge injection inhibition layer 102, the photoconductive layer 103, the upper charge injection inhibition layer 104 and the surface layer 105 are shown.

Each layer in FIG. 1 can be formed with a vacuum deposition film-forming method and more specifically with a high-frequency CVD method and the like, and by appropriately setting numerical conditions of film formation parameters so that the desired characteristics can be obtained.

(Conductive Substrate)

Materials for the conductive substrate can include, for instance, copper, aluminum, nickel, cobalt, iron, chromium, molybdenum, titanium, and alloys of these elements. Among them, aluminum can be used from the viewpoints of workability and the manufacturing cost. Among aluminum, an Al—Mg-based alloy or an Al—Mn-based alloy can be used. Hereafter, the conductive substrate is merely referred to as “a substrate” as well.

(Lower Charge Injection Inhibition Layer)

In the electrophotographic photosensitive member according to the present invention, a lower charge injection inhibition layer is provided between the substrate and a photoconductive layer. The lower charge injection inhibition layer plays a role of blocking the injection of an electric charge into the photoconductive layer from a substrate side. In addition, the lower charge injection inhibition layer is formed from amorphous silicon. The lower charge injection inhibition layer can contain more atoms for controlling its conductivity than the photoconductive layer. The Group 13 atoms or the Group 15 atoms of the Periodic Table can be used according to an charging polarity, as an atom for controlling the conductivity.

Furthermore, the lower charge injection inhibition layer can enhance the adhesiveness between itself and the substrate by containing atoms such as a carbon atom, a nitrogen atom and an oxygen atom in addition to a silicon atom.

The film thickness of the lower charge injection inhibition layer can be 0.1 μm or more and 10 μm or less, further 0.3 μm or more and 5 μm or less, and still further 0.5 μm or more and 3 μm or less, from viewpoints of charging ability and economical efficiency. By controlling its film thickness to 0.1 μm or more, the lower charge injection inhibition layer can show a sufficient capability of blocking the injection of the electric charge from the substrate and obtain desirable charging ability. On the other hand, an increase in the manufacturing cost of the electrophotographic photosensitive member due to the extension of a manufacturing period of time can be suppressed by controlling the film thickness to 10 μm or less.

(Photoconductive Layer)

A photoconductive layer of the electrophotographic photosensitive member according to the present invention is formed from a-Si (amorphous silicon). In addition, the photoconductive layer can contain an atom for controlling its conductivity. The Group 13 atoms or the Group 15 atoms of the Periodic Table can be used as an atom for controlling the conductivity.

Furthermore, the photoconductive layer may contain atoms such as an oxygen atom, a carbon atom and a nitrogen atom, in addition to a silicon atom, in order to adjust its characteristics such as resistance. In addition, the photoconductive layer can contain halogen atoms such as a hydrogen atom and a fluorine atom, in order to compensate an uncombined hand (a dangling bond) in a-Si.

The number (H) of hydrogen atoms in the photoconductive layer can be 10 atom % or more and further 15 atom % or more with respect to the sum of the number (Si) of silicon atoms and the number of the hydrogen atoms in the photoconductive layer, and on the other hand, can be 30 atom % or less and further 25 atom % or less.

In the present invention, the film thickness of the photoconductive layer can be 15 μm or more and 80 μm or less, and further 40 μm or more and 80 μm or less, from the viewpoint of charging ability. The photoconductive layer improves its charging characteristics by controlling its film thickness to 15 μm or more, accordingly can reduce the amount of an charging current and can reduce a product by electric discharge, which is effective to the surface deterioration. In addition, it is possible to suppress the growth of an abnormally growing part of a-Si by controlling the film thickness of the photoconductive layer to 80 μm or less.

(Upper Charge Injection Inhibition Layer)

In the electrophotographic photosensitive member of the present invention, an upper charge injection inhibition layer is provided between a photoconductive layer and a surface layer. The upper charge injection inhibition layer plays a role of blocking the injection of an electric charge from the upper part and enhancing charging ability, and also plays a role of preventing such a phenomenon that photocarriers flow into a part to which the photocarriers are easy to move when a large amount of the photocarriers are generated by irradiation with a strong exposure light.

When a surface layer with high resistance is stacked on the photoconductive layer, carriers having an opposite polarity to the charging polarity of carriers generated by the irradiation with light occasionally accumulate in the boundary between these two layers due to a difference of electric characteristics between these two layers. As a result, there has been the case in which a letter part is blurred and gradation properties are degraded by the transverse flow of these carriers.

When the upper charge injection inhibition layer contains the Group 13 atoms or the Group 15 atoms of the Periodic Table according to the charging polarity, the optimum resistance can be consequently adjusted, at which the upper charge injection inhibition layer prevents the transverse flow while passing the carriers having opposite polarity to the charging polarity therethrough. For this reason, an electrophotographic photosensitive member having adequate gradation properties is obtained.

In the present invention, the upper charge injection inhibition layer of the electrophotographic photosensitive member has C/(Si+C) controlled in a range of 0.10 or more and 0.60 or less.

In addition, the upper charge injection inhibition layer contains the Group 13 atoms or the Group 15 atoms of the Periodic Table, as an atom for controlling the conductivity according to the charging polarity.

When the C/(Si+C) is 0.10 or more, and the content of the Group 13 atoms or the Group 15 atoms of the Periodic Table is 30,000 atom ppm or less with respect to that of silicon atoms, adequate gradation properties can be obtained without impairing the capability of inhibiting charge injection.

Furthermore, when the C/(Si+C) is 0.60 or less, and the content of the Group 13 atoms or the Group 15 atoms of the Periodic Table is 10 atom ppm or more, a remarkable effect of the Group 13 atoms or the Group 15 atoms of the Periodic Table as a dopant can be shown, and the electrical resistance can be stably controlled.

In other words, it is necessary that the upper charge injection inhibition layer contains 10 atom ppm or more and 30,000 atom ppm or less of the Group 13 atoms or the Group 15 atoms of the Periodic Table with respect to the content of silicon atoms in the upper charge injection inhibition layer, and that the (C/(Si+C)) in the upper charge injection inhibition layer is 0.10 or more and 0.60 or less.

In the present invention, the film thickness of the upper charge injection inhibition layer can be 0.01 to 0.5 μm from the viewpoints of sufficiently showing the capability of blocking the charge injection from the surface and not giving influence on the image quality.

(Surface Layer)

The surface layer of the electrophotographic photosensitive member according to the present invention is a layer formed from a-SiC (hydrogenated amorphous silicon carbide).

In the present invention, it is characterized that the ratio C/(Si+C) in an a-SiC surface layer is in a range of 0.61 or more and 0.75 or less, and the Si+C atom density is 6.60×10^{22 atoms/cm}³ or more. The Si+C atom density can be further 6.81×10^{22 atoms/cm}³ or more.

By such a control, a large effect of preventing the surface deterioration for a long period of time can be obtained. This reason will be described below.

The deterioration of a-SiC occurs by that a bond between the silicon atom and the carbon atom is cleaved by the oxidization and detachment of the carbon atom of the a-SiC and an oxidizing substance reacts with a dangling bond of a newly generated silicon atom. In this respect, the surface layer according to the present invention can make the bond between the silicon atom and the carbon atom hardly cleaved by increasing the Si+C atom density in the a-SiC surface layer. In addition, the increase of the Si+C atom density leads to the decrease of a rate of space in the a-SiC surface layer, and consequently leads to the decrease of the probability of causing a reaction between the carbon atom and the oxidizing substance. In an electrophotographic process, it is considered that the carbon atom is oxidized and detached by the reaction of an ion species generated in an electrification step with the carbon atom. Accordingly, the oxidization of the silicon atom is suppressed by suppressing the oxidization of the carbon atom.

The a-SiC surface layer according to the present invention makes the distance between atoms constituting the a-SiC surface layer shortened and the rate of space decreased, and consequently can suppress the surface deterioration.

From the above described viewpoints, the Si+C atom density in the a-SiC surface layer can be higher, and the surface deterioration can be further suppressed by controlling the Si+C atom density to 6.81×10²² atoms/cm³ or more. It is also necessary for obtaining superior characteristics of the electrophotographic photosensitive member to control the Si+C atom density in the a-SiC surface layer in the above described range, and the C/(Si+C) in the a-SiC surface layer to 0.61 or more and 0.75 or less.

When the C/(Si+C) in the a-SiC surface layer is made to be smaller than 0.61, the resistance of the a-SiC occasionally decreases when the a-SiC having high atom density has been produced in particular. In such a case, the carriers easily cause the transverse flow in the surface layer when the electrostatic latent image is formed. Therefore, when isolated dots are formed for the electrostatic latent image, the isolated dots become small due to the transverse flow of the carriers in the surface layer. As a result, in the output image, the image density decreases particularly in a lower density side, which occasionally lowers the gradation properties. For these reasons, in the a-SiC surface layer having high atom density such as in the present invention, it is necessary to control the C/(Si+C) to 0.61 or more.

In addition, when the C/(Si+C) is made to be larger than 0.75, the light absorption in the a-SiC surface layer occasionally rapidly increases, particularly when the a-SiC having high atom density has been produced. In such a case, the light quantity of the image-exposing light necessary when the electrostatic latent image is formed increases, and the sensitivity is extremely lowered. For these reasons, in the a-SiC surface layer having high atom density such as in the present invention, it is necessary to control the C/(Si+C) to 0.75 or less.

From the above described reasons, in order to suppress the deterioration of the a-SiC surface layer while keeping desirable characteristics of the electrophotographic photosensitive member, the following operations become necessary. In other words, it is necessary to control the Si+C atom density in the a-SiC surface layer to 6.60×10^{22 atoms/cm}³ or more, and the C/(Si+C) in the a-SiC surface layer to 0.61 or more and 0.75 or less.

Here, in the a-SiC, the atom density of 13.0×10²² atom/cm³, which is that of standing most high-density, is the upper limit of the Si+C atom density.

In the present invention, the ratio (H/(Si+C+H)) of the number (H) of hydrogen atoms with respect to the sum (Si+C+H) of the number (Si) of silicon atoms, the number (C) of carbon atoms and the number (H) of the hydrogen atoms in the a-SiC surface layer can be controlled to 0.30 or more and 0.45 or less. Thereby, the electrophotographic photosensitive member can be obtained which has further adequate characteristics of the electrophotographic photosensitive member and further excellently suppresses the surface deterioration. For information, the ratio of the number of the hydrogen atoms with respect to the sum of the number of the silicon atoms, the number of the carbon atoms and the number of the hydrogen atoms is referred to as “H/(Si+C+H)” as well.

In the a-SiC surface layer having high atom density, the optical band gap is narrowed, and there is a case in which the sensitivity is lowered by the increase of the light absorption. However, when the H/(Si+C+H) in the a-SiC surface layer is controlled to 0.30 or more, the optical band gap is expanded, and thereby the sensitivity can be enhanced.

On the other hand, when the H/(Si+C+H) in the a-SiC surface layer is controlled to more than 0.45, a terminal group having many hydrogen atoms such as a methyl group tends to increase in the a-SiC surface layer. When many terminal groups having a plurality of hydrogen atoms such as a methyl group exist in the a-SiC surface layer, a large space is formed in the a-SiC structure, and distortion is also formed in bonds among atoms existing in the periphery. It is considered that such a structurally weak portion becomes a portion having a weakness against oxidization. When a large amount of hydrogen atoms are contained in the a-SiC surface layer, networking among the silicon atoms and the carbon atoms which are skeleton atoms of the a-SiC surface layer becomes hard to be promoted.

From such reasons, it is considered that by controlling the H/(Si+C+H) to 0.45 or less, the networking among the silicon atoms and the carbon atoms which are the skeleton atoms of the a-SiC surface layer can be promoted, and the distortion formed in the bonds among the atoms can be reduced. As a result, the effect of suppressing the surface deterioration in the a-SiC surface layer is further enhanced.

In the present invention, the ratio (ID/IG) of the peak intensity (ID) of 1390 cm⁻¹ with respect to the peak intensity (IG) of 1480 cm⁻¹ in a Raman spectrum of the a-SiC surface layer can be controlled to 0.20 or more and 0.70 or less. For information, the ratio of the peak intensity of 1390 cm⁻¹ with respect to the peak intensity of 1480 cm⁻¹ in the Raman spectrum is referred to as “ID/IG” as well.

Firstly, the Raman spectrum of the a-SiC surface layer will be described below while being compared with that of diamond like carbon. For information, the diamond like carbon is referred to as “DLC” as well.

The observed Raman spectrum of DLC formed from a sp³ structure and a sp² structure is an asymmetrical Raman spectrum which has a main peak in the vicinity of 1540 cm⁻¹ and has a shoulder band in the vicinity of 1390 cm⁻¹. In the a-SiC surface layer formed with an RF-CVD method, the observed Raman spectrum has a main peak in the vicinity of 1480 cm⁻¹, has a shoulder band in the vicinity of 1390 cm⁻¹, and is similar to that in the DLC. The reason why the main peak of the a-SiC surface layer is shifted to a lower-frequency side than that of the DLC is because the silicon atom is contained in the a-SiC surface layer.

It is understood from the above observation result that the a-SiC surface layer formed with the RF-CVD method is a material having an extremely similar structure to that of the DLC.

In the Raman spectrum of the DLC, it is generally known that as the ratio of the peak intensity at a low-frequency band with respect to the peak intensity at a high-frequency band is small, an ratio of sp³ structure of the DLC tends to be high. Accordingly, it is considered that as the ratio of the peak intensity at a low-frequency band with respect to the peak intensity at a high-frequency band is small, the ratio of sp³ structure tends to be high in the a-SiC surface layer as well, because a-SiC surface layer has an extremely similar structure to that of DLC.

In the a-SiC surface layer having high atom density of the present invention, the surface deterioration can further be suppressed by controlling the ID/IG in the a-SiC surface layer to 0.70 or less.

This reason is considered to be because the ratio of sp³ structure is enhanced, the number of two-dimensional networks due to the sp² decreases and three-dimensional networks due to the sp³ increase, which increases the number of bonds among the skeleton atoms and can form a strong structure.

Accordingly, the ID/IG in the a-SiC surface layer further can be small, but the sp² structure cannot be completely removed in the a-SiC surface layer which is formed in a mass production level. Accordingly, in the present invention, the lower limit of the ID/IG in the a-SiC surface layer is determined to be 0.2 at which the effect of suppressing the deterioration of the surface layer has been confirmed in the present example.

In the present invention, a method for forming the above described a-SiC surface layer may be any method as long as the method can form such a layer as to satisfy the above described specification. Specifically, the method includes a plasma CVD method, a vacuum vapor-deposition method, a sputtering method and an ion plating method. Among them, the plasma CVD method can be used because the raw material can be easily obtained.

When the plasma CVD method is selected as a method for forming the a-SiC surface layer, the method for forming the a-SiC surface layer is as follows.

Specifically, a source gas for supplying a silicon atom and a source gas for supplying a carbon atom are introduced into a reaction vessel which can decompress its inner part, in a desired gas state, and glow discharge is generated in the reaction vessel. A layer formed from a-SiC may be formed on the conductive substrate which has been previously arranged in a predetermined position, by decomposing the source gas which has been introduced into the reaction vessel.

As a source gas for supplying the silicon atom, silanes such as silane (SiH₄) and disilane (Si₂H₆) can be used, for instance. As a source gas for supplying the carbon atom, gases such as methane (CH₄) and acetylene (C₂H₂) can be used, for instance. In addition, hydrogen (H₂) may be used together with the above described source gases for the purpose of mainly adjusting H/(Si+C+H).

When the a-SiC surface layer of the present invention is formed, the Si+C atom density tends to become high by reducing an amount of the gas to be supplied to the reaction vessel, and by increasing the high-frequency power or raising the temperature of a substrate. Practically, these conditions may be set while being appropriately combined.

<Manufacturing Apparatus and Manufacturing Method for Manufacturing Electrophotographic Photosensitive Member of Present Invention>

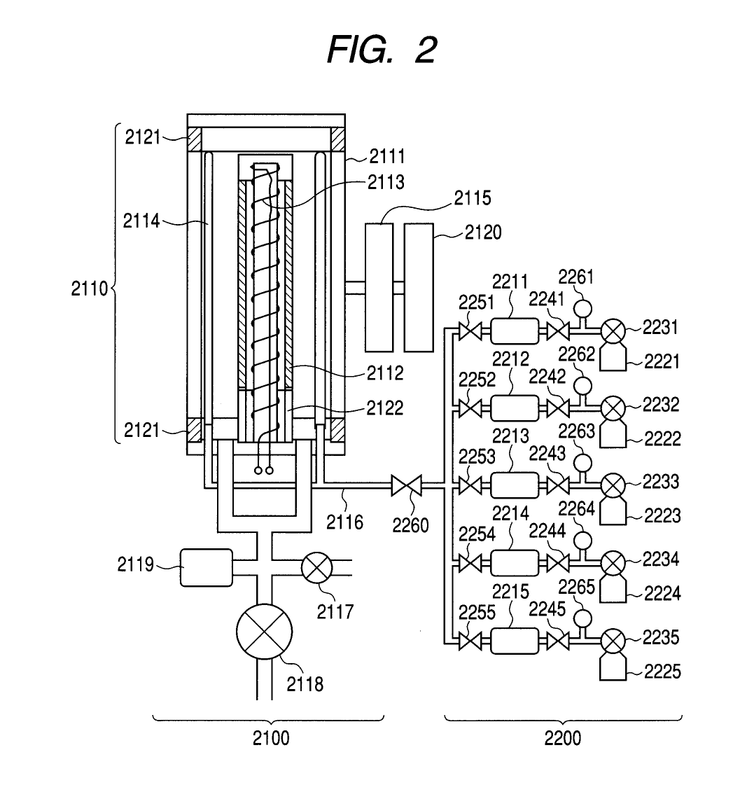

FIG. 2 is a view schematically illustrating one example of a deposition apparatus for a photosensitive member with an RF plasma CVD method with the use of a high-frequency power for producing an a-Si-based photosensitive member of the present invention.

If this apparatus is roughly divided, the apparatus comprises a deposition device 2100 having a reaction vessel 2110, a source gas supply device 2200, and an exhaust device (not shown) for decompressing the inner part of the reaction vessel 2110.

The reaction vessel 2110 has a conductive substrate 2112 connected to the ground, a heater 2113 for heating the conductive substrate and a source gas introduction pipe 2114, arranged therein. Furthermore, a high-frequency power source 2120 is connected to a cathode 2111 through a high-frequency matching box 2115.

The source gas supply device 2200 comprises bombs of source gases 2221 to 2225, valves 2231 to 2235, pressure controllers 2261 to 2265, inflow valves 2241 to 2245, outflow valves 2251 to 2255 and mass flow controllers 2211 to 2215. Bombs having the respective source gases sealed therein are connected to the source gas introduction pipe 2114 in the reaction vessel 2110 through an auxiliary bulb 2260. The source gas includes SiH₄, H₂, CH₄, NO and B₂H₆.

Next, a method for forming a deposited film with the use of this apparatus will be described below. Firstly, a conductive substrate 2112 which has been previously degreased and cleaned is mounted on a cradle 2122 in the reaction vessel 2110. Subsequently, an exhaust device (not shown) is operated, and the inside of the reaction vessel 2110 is exhausted. When the pressure in the reaction vessel 2110 has reached a predetermined pressure, for instance, of 1 Pa or lower, an operator shall supply an electric power to a heater 2113 for heating the substrate to heat the conductive substrate 2112 to a desired temperature, for instance, of 50 to 350° C., while watching a display of a vacuum gage 2119. At this time, by supplying an inert gas such as Ar and He from the gas supply device 2200 to the reaction vessel 2110, the conductive substrate 2112 can be heated also in the inert gas atmosphere.

Subsequently, a gas to be used for forming the deposited film is supplied from the gas supply device 2200 to the reaction vessel 2110. Specifically, the valves 2231 to 2235, the inflow valves 2241 to 2245 and the outflow valves 2251 to 2255 are opened as needed, and the flow rates of the mass flow controllers 2211 to 2215 are set. When the flow rate of each of the mass flow controllers becomes stable, an operator shall operate a main bulb 2118 to adjust the pressure in the reaction vessel 2110 to a desired pressure, while watching the display of the vacuum gage 2119. When the desired pressure is obtained, an operator shall apply the high-frequency power to the reaction vessel 2110 from the high-frequency power source 2120, and simultaneously shall operate the high-frequency matching box 2115 to generate plasma discharge in the reaction vessel 2110. Then, the high-frequency power is immediately controlled to a desired electric power to form the deposited film.

When the formation of the predetermined deposited film has been finished, the application of the high-frequency power is stopped, the valves 2231 to 2235, the inflow valves 2241 to 2245, the outflow valves 2251 to 2255 and the auxiliary bulb 2260 are closed, and the supply of the source gas is finished. At the same time, the main valve 2118 is fully opened to exhaust the inside of the reaction vessel 2110 down to the pressure of 1 Pa or lower.

By the above described steps, the formation of the deposited layer is finished, but when a plurality of deposited layers are formed, the respective layers may be formed by repeating the above described steps again. In addition, when a plurality of layers are continuously formed, the joining regions can be also formed by changing a flow rate of a source gas and a pressure and the like to conditions for forming the subsequent layer in a fixed period of time.

After the formation of all deposited films has been finished, the main valve 2118 is closed, an inert gas is introduced into the reaction vessel 2110 to return the pressure to atmospheric pressure, and the conductive substrate 2112 is taken out.

The electrophotographic photosensitive member of the present invention forms the surface layer having a film structure having high atom density thereon by increasing the atom densities of the silicon atom and the carbon atom constituting the a-SiC compared to those in the surface layer of a conventionally known electrophotographic photosensitive member. As was described above, when the a-SiC surface layer having high atom density of the present invention is produced, the amount of the gas to be supplied to the reaction vessel can be generally little, and any of the high-frequency power, the pressure in the reaction vessel and the temperature of the conductive substrate can be generally high, through depending on a condition when the surface layer is formed.

The decomposition of the gas can be promoted by reducing the amount of the gas to be supplied into the reaction vessel and increasing the high-frequency power. Thereby, a carbon atom supply source (CH₄, for instance) which is harder to decompose than a silicon atom supply source (SiH₄, for instance) can be efficiently decomposed. As a result, active species containing a few hydrogen atoms are formed, hydrogen atoms in the film deposited on the conductive substrate decrease, and consequently an a-SiC surface layer having high atom density can be formed.

In addition, a staying period of the source gas supplied to the reaction vessel in the reaction vessel is extended by increasing the pressure in the reaction vessel. In addition, an reaction of extracting for weakly-bonded hydrogen atoms occurs by hydrogen atoms produced by the decomposition of the source gas. As a result, it is considered that networking of the silicon atom with the carbon atom is promoted.

Furthermore, the movement distance of the active species on the surface, which have reached the conductive substrate, is elongated by raising the temperature of the conductive substrate, and more stable bonds can be formed. As a result, it is considered that each atom can be bonded to form more stable arrangement structurally in the a-SiC surface layer. <Electrophotographic apparatus with the use of electrophotographic photosensitive member of present invention>

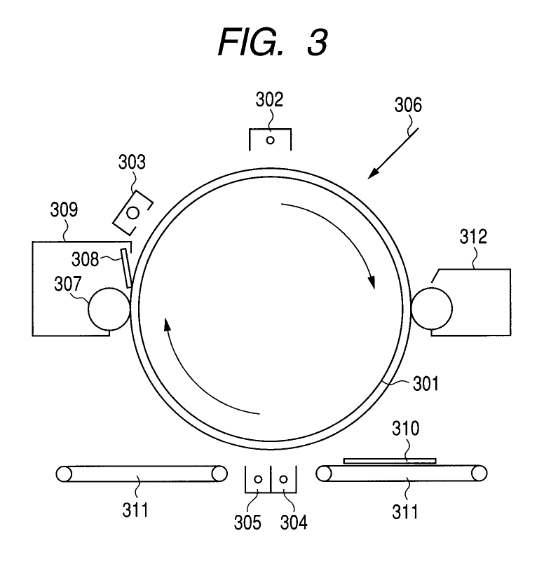

A method for forming an image by the electrophotographic apparatus with the use of an a-Si photosensitive member will be described below with reference to FIG. 3.

Firstly, an electrophotographic photosensitive member 301 is rotated, and the surface of the electrophotographic photosensitive member 301 is uniformly charged by a main charging assembly (charging unit) 302. Then, the surface of the electrophotographic photosensitive member 301 is irradiated with an image-exposing light 306 emitted from an image-exposing device (image-exposing unit (electrostatic latent-image-forming unit)) (not shown) to form an electrostatic latent image on the surface of the electrophotographic photosensitive member 301 and the latent image is developed by a toner which is supplied from a developing apparatus (developing unit) 312. As a result, a toner image is formed on the surface of the electrophotographic photosensitive member 301. This toner image is transferred onto a transfer material 310 by a transfer charging assembly (transferring unit) 304, the transfer material 310 is separated from the electrophotographic photosensitive member 301, and the toner image is fixed on the transfer material 310.

On the other hand, the toner remaining on the surface of the electrophotographic photosensitive member 301 onto which the toner image has been transferred is removed with a cleaner 309, then the all regions on the surface of the electrophotographic photosensitive member 301 are exposed to light by a charge eliminator 303, and thereby the carrier remaining on the electrophotographic photosensitive member 301 when the electrostatic latent image has been formed is electrostatically eliminated. The image is continuously formed by repeating the above series of the processes.

The present invention will be described further in detail below with reference to examples, but the present invention is not limited to these examples.

### Example 1

An electrophotographic photosensitive member to be negatively charged was produced on a cylindrical substrate (cylindrical substrate made from aluminum, which had a diameter of 80 mm, a length of 358 mm and a thickness of 3 mm, and was mirror-finished) by using a plasma treatment apparatus which is illustrated in FIG. 2 and uses a high-frequency power source that employs RF bands as a frequency, according to the following conditions shown in Table 1. At this time, a lower charge injection inhibition layer, a photoconductive layer, an upper charge injection inhibition layer and a surface layer were formed (layer formation) in this order. In addition, when the surface layer was formed, a high-frequency electric power, an SiH₄ flow rate and a CH₄ flow rate were set at conditions shown in Table 2. In addition, two electrophotographic photosensitive members to be negatively charged were produced for each film-forming condition.

A produced electrophotographic photosensitive member to be negatively charged was mounted in the electrophotographic apparatus having the following structure, and was subjected to the evaluation which would be described later.

An electrophotographic apparatus was prepared by remodeling an electrophotographic apparatus iR-5065 (trade name) which was made by Canon Inc., had the structure illustrated in FIG. 3 and was used as the base, so as to fit a negatively chargeable process and so as to have a modified process speed of 300 mm/sec.

Furthermore, in order to evaluate the changes of the characteristics due to the durability test, the electrophotographic apparatus was modified so that the potential control unit for its surface potential did not work.

TABLE 1

| | Lower | | Upper | |
|---|---|---|---|---|
| | charge | | charge | |
| | injection | Photo- | injection | |
| | inhibition | conductive | inhibition | Surface |
| | layer | layer | layer | layer |
| Type of gas and flow rate | | | | |
| SiH₄ [mL/min (normal)] | 350 | 450 | 250 | * |
| H₂ [mL/min (normal)] | 750 | 2200 | | |
| PH₃ [ppm] (vs. SiH₄) | 1500 | | | |
| B₂H₆ [ppm] (vs. SiH₄) | | | 900 | |
| NO [mL/min (normal)] | 10 | | | |
| CH₄ [mL/min (normal)] | | | 310 | * |
| Internal pressure [Pa] | 40 | 80 | 55 | 80 |
| High-frequency power [W] | 400 | 900 | 400 | * |
| Substrate temperature [° C.] | 260 | 260 | 260 | 290 |
| Film thickness [μm] | 3.3 | 25 | 0.2 | 0.5 |

TABLE 2

| Film-forming condition No. | 1 | 2 | 3 | 4 |
|---|---|---|---|---|
| SiH₄ [mL/min (normal)] | 26 | 26 | 26 | 26 |
| CH₄ [mL/min (normal)] | 500 | 450 | 400 | 360 |
| High-frequency power (W) | 800 | 750 | 750 | 700 |

Each of the two electrophotographic photosensitive members to be negatively charged which had been produced according to each film-forming condition in Example 1 was evaluated on conditions which would be described later. Firstly, by using one electrophotographic photosensitive member to be negatively charged for each film-forming condition, C/(Si+C), the atom density of silicon atoms (hereafter referred to as “Si atom density” as well), the atom density of carbon atoms (hereafter referred to as “C atom density” as well), the Si+C atom density and the atom density of hydrogen atoms (hereafter referred to as “H atom density” as well), the H atom ratio (which means H/(Si+C+H) and is hereafter the same) and the ratio of sp³ structure were determined with the analysis method which would be described later. In addition, the C/(Si+C), the Si atom density and the C atom density of the upper charge injection inhibition layer were also determined with the analysis method which would be described later. In addition, the content of boron atoms in the upper charge injection inhibition layer was measured with SIMS (secondary ion mass spectrometry) (product made by CAMECA SAS, trade name: IMS-4F).

Then, the adhesiveness, the sensitivity irregularity, the gradation properties and the sensitivity were evaluated on the other one electrophotographic photosensitive member to be negatively charged for each film-forming condition, on evaluation conditions which would be described later.

These results are shown in Table 5 and Table 6. In addition, the content of the boron atoms with respect to that of the silicon atoms of the upper charge injection inhibition layer was in the range of 300 atom ppm ±10 atom ppm, and the C/(Si+C) in the upper charge injection inhibition layer was in the range of 0.30±0.01.

(Measurement for C/(Si+C), Si Atom Density, C Atom Density, Si+C Atom Density, H Atom Density and H Atom Ratio of Surface Layer)

Firstly, a reference electrophotographic photosensitive member was produced in which only the lower charge injection inhibition layer, the photoconductive layer and the upper charge injection inhibition layer in Table 1 were formed, and a reference sample was produced by cutting out the central portion in the longitudinal direction at an arbitrary point in a peripheral direction, into a 15 mm square (15 mm×15 mm). Subsequently, a sample for measurement was produced by similarly cutting out the electrophotographic photosensitive member in which the lower charge injection inhibition layer, the photoconductive layer, the upper charge injection inhibition layer and a surface layer were formed. The film thickness of the surface layer was determined by subjecting the reference samples and the samples for measurement to measurement with spectral ellipsometry (product made by J.A. Woollam Co., Inc.: high speed spectral ellipsometry M-2000). As for specific measurement conditions of the spectral ellipsometry, an incident angle was set at 60°, 65° and 70°, the measurement wavelength was set at 195 nm to 700 nm, and the beam diameter was set at 1 mm×2 mm.

Firstly, the reference sample was subjected to measurement by the spectral ellipsometry, and a relationship between the wavelength and each of an amplitude ratio Ψ and a phase difference Δ, was determined at each incident angle.

Subsequently, the sample for measurement was subjected to the measurement with the spectral ellipsometry in a similar way to that for the reference sample, and the relationship between the wavelength and each of the amplitude ratio Ψ and the phase difference Δ was determined at each incident angle, while using the measurement result of the reference sample as reference.

Furthermore, the relationship between the wavelength and each of the Ψ and the Δ at each incident angle was determined through calculation with an analysis software, by using a layer structure having a rough layer in which the surface layer and an air layer coexist on the surface of the electrophotographic photosensitive member in which the lower charge injection inhibition layer, the photoconductive layer, the upper charge injection inhibition layer and the surface layer were sequentially stacked, as a calculation model. Then, the calculation model was selected according to which the mean square error of the relationships between the wavelength and each of the Ψ and the Δ determined by the above described calculation at each incident angle, and the relationships between the wavelength and each of the Ψ and the Δ determined by the measurement result of the samples for measurement at each incident angle, became smallest. The film thickness of the surface layer was calculated by this selected calculation model, and the obtained value was determined to be the film thickness of the surface layer. For information, WVASE32 made by J.A. Woollam Co., Inc. was used as the analysis software. In addition, the volume ratio of the surface layer to the air layer in the rough layer was calculated by changing the ratio of the air layer in the rough layer one by one from 10:0 to 1:9, which represent surface layer:air layer.

In the electrophotographic photosensitive members to be negatively charged which had been produced for each film-forming condition in the present example, the mean square error of the relationships between the wavelength and each of the Ψ and the Δ determined by the calculation when the volume ratio of the surface layer to the air layer in the rough layer was 8:2, and the relationships between the wavelength and each of the Ψ and the Δ determined by the measurement result of the samples for measurement, became smallest.

After the measurement with the spectral ellipsometry had been finished, the above described sample for measurement was subjected to the analysis by RBS (Rutherford backward scattering method) (backward-scattering measurement instrument made by NHV Corporation, trade name: AN-2500), and the numbers of silicon atoms and carbon atoms in the surface layer in the measurement area of RBS were measured. The C/(Si+C) was determined from the measured numbers of the silicon atoms and the carbon atoms. Subsequently, the Si atom density, the C atom density and the Si+C atom density were determined with respect to the silicon atoms and the carbon atoms which had been determined in the measurement area of RBS, by using the film thickness of the surface layer which had been determined with the spectral ellipsometry.

The above described sample for measurement was subjected to the analysis by HFS (hydrogen forward-scattering method) (back-scattering measurement instrument AN-2500 made by NHV Corporation) simultaneously with the analysis by RBS, and the number of hydrogen atoms in the surface layer in the measurement area of HFS was measured. The H atom ratio was determined by using the number of the hydrogen atoms, which had been determined in the measurement area of HFS, and the number of the silicon atoms and the number of the carbon atoms, which had been determined in the measurement area of RBS. Subsequently, the H atom density was determined by using the film thickness of the surface layer which had been determined with the spectral ellipsometry with respect to the number of the hydrogen atoms, which had been determined in the measurement area of HFS.

As for specific measurement conditions of RBS and HFS, an incident ion was set at ⁴He⁺, an incident energy was set at 2.3 MeV, an incident angle was set at 75°, a sample current was set at 35 nA, and an incident beam diameter was set at 1 mm. In the detector of RBS, a scatter angle was set at 160 degrees, and an aperture diameter was set at 8 mm. In the detector of HFS, a recoil angle was set at 30°, and an aperture diameter was set at 8 mm+Slit, in measurement.

(Measurement for C/(Si+C) in Upper Charge Injection Inhibition Layer)

Firstly, an electrophotographic photosensitive member was produced in which the lower charge injection inhibition layer, the photoconductive layer and the upper charge injection inhibition layer were formed, and a sample for measurement was produced by cutting out the central portion in the longitudinal direction at an arbitrary point in a peripheral direction, into a 15 mm square.

The above described sample for measurement was subjected to the analysis by RBS (Rutherford backward scattering method) (backward-scattering measurement instrument AN-2500 made by NHV Corporation), and the numbers of silicon atoms and carbon atoms in the upper charge injection inhibition layer in the measurement area of RBS were measured. The C/(Si+C) was determined from the measured numbers of the silicon atoms and the carbon atoms. As for specific measurement conditions of RBS, an incident ion was set at ⁴He+, an incident energy was set at 2.3 MeV, an incident angle was set at 75°, a sample current was set at 35 nA, and an incident beam diameter was set at 1 mm. In the detector of RBS, a scatter angle was set at 160°, and an aperture diameter was set at 8 mm, in measurement.

(Measurement for Content of Boron Atom in Upper Charge Injection Inhibition Layer)

Firstly, an electrophotographic photosensitive member was produced in which the lower charge injection inhibition layer, the photoconductive layer and the upper charge injection inhibition layer were formed, and a sample for measurement was produced by cutting out the central portion in the longitudinal direction at an arbitrary point in a peripheral direction, into a 15 mm square.

The content of boron atoms with respect to that of the silicon atoms in the upper charge injection inhibition layer was measured by using the sample for measurement and SIMS (secondary ion mass spectrometry) (made by CAMECA SAS, trade name: IMS-4F).

(Adhesiveness 1)

A remodeled machine was used for the evaluation, which was prepared by remodeling an electrophotographic apparatus iR-5065 (trade name) made by Canon Inc. so as to fit a negatively chargeable process and has a modified process speed of 300 mm/sec.

A produced electrophotographic photosensitive member was mounted in the electrophotographic apparatus, a testing chart on which letters of 2 point were written on the whole surface in a white background was placed on the document stage, and images with an A4 size were output (copied) on 1,000,000 sheets. In addition, the electrophotographic photosensitive member to be negatively charged is taken out every time after images have been output on 250,000 sheets, is left in a container which is controlled to a temperature of −30° C., for 12 hours, and then is immediately left in a container which is controlled to a temperature of +50° C. and a relative humidity of 95%, for 12 hours. This cycle was repeated for 2 cycles, then, the surface of the electrophotographic photosensitive member was observed, and the presence or absence of film exfoliation was checked. The obtained results were ranked based on the following criteria.

A: a level in which film exfoliation is not observed at all

B: a level in which film exfoliation occurs in an amount of less than 1% with respect to the whole region of the surface layer

C: a level in which film exfoliation occurs in an amount of 1% or more and less than 10% with respect to the whole region of the surface layer

D: a level in which film exfoliation occurs in an amount of 10% or more with respect to the whole region of the surface layer

(Adhesiveness 2)

The electrophotographic photosensitive member after the adhesiveness 1 had been evaluated was mounted on HEIDON (Type: 14S) made by Shinto Scientific Co., Ltd., the surface of the electrophotographic photosensitive member was scratched with a diamond needle, and the adhesiveness was evaluated with a load applied to the diamond needle when exfoliation occurred on the surface of the electrophotographic photosensitive member.

The evaluation results were subjected to the relative evaluation which determines the rank while considering the value of a film-forming condition No. 6 in Comparative Example 1 as 100%, and were ranked based on the criteria described below. In addition, in this evaluation, as the load applied to the diamond needle when the exfoliation has occurred on the surface of the electrophotographic photosensitive member is large, the adhesiveness is superior and adequate.

A: 100% or more

B: 80% or more and less than 100%

C: 60% or more and less than 80%

D: less than 60%

(Sensitivity Irregularity)

A remodeled machine was used for the evaluation, which was prepared by remodeling an electrophotographic apparatus iR-5065 (trade name) made by Canon Inc. so as to fit a negatively chargeable process and has a modified process speed of 300 mm/sec.

A produced electrophotographic photosensitive member was mounted in the electrophotographic apparatus, and the amount of an electric current to be supplied to the main charging assembly was controlled in a state of having turned the image-exposing light off so that the potential of a dark portion (dark potential) could be −500 V at the position of a developing apparatus at the center position in the longitudinal direction of the electrophotographic photosensitive member. After that, the image-exposing light was emitted, and the light quantity of the image-exposing light was controlled so that the potential of light portion (light potential) at the position of the developing apparatus could be −100 V. In this state, the distribution of potential difference between the dark potential and the light potential (dark potential—light potential) in the electrophotographic photosensitive member was measured at the following positions, and the difference between the ratio (%) of the maximum value to the minimum value and 100% was measured to be potential irregularity.

The potential distribution was measured at positions of 9 points in a longitudinal direction of the electrophotographic photosensitive member (0 mm, ±50 mm, ±90 mm, ±130 mm and ±150 mm with respect to the center in the longitudinal direction of the electrophotographic photosensitive member).

The result was ranked from the ratio of the maximum value to the minimum value of the measurement values at the 9 points, based on the criteria described below.

In addition, the sensitivity irregularity was evaluated in every 250,000 sheets up to 1,000,000 sheets of image outputs which were carried out along with the above described evaluation of the adhesiveness 1.

In the evaluation criteria, if the sensitivity irregularity was evaluated to be B or higher at the time when images with an A4 size were output (copied) on 1,000,000 sheets, the effect of the present invention was considered to be obtained, and the sensitivity irregularity was determined to excellently suppress the surface deterioration.

A: less than 1.0% of the potential irregularity and an adequate image

B: a level in which there is 1.0% or more and less than 2.5% of the potential irregularity but no density unevenness in the image.

C: having caused 2.5% or more of the potential irregularity, and having caused density unevenness in the image

(Evaluation for Gradation Properties)

The gradation properties were evaluated with the use of a remodeled machine of “iR-5065 (trade name)” which is an electrophotographic apparatus made by Canon Inc. At first, a gradation data was prepared in which the whole gradation range was equally divided into 18 steps according to an area gradation with the use of an area gradation dot screen (in other words, area gradation of dot portions which are to be exposed to the image-exposing light) having a line density of 170 lpi (170 lines per one inch) in 45 degrees by an image-exposing light. At this time, the gradation steps were formed by setting the darkest gradation at 17, setting the lightest gradation at 0, and assigning numbers to each gradation.

Next, the produced electrophotographic photosensitive member was arranged in the above described remodeled electrophotographic apparatus, and an image was output on an A3 paper in a text mode by using the above described gradation data. In the above description, the image was output in the evaluation environment of the temperature of 22° C. and the relative humidity of 50%, and on the condition of keeping the surface of the electrophotographic photosensitive member at 40° C. by turning a heater for the photosensitive member ON.

The image density of each gradation in the obtained image was measured with a reflection densitometry (504 spectral densitometry: product made by X-Rite, Incorporated). For information, when the reflection density was measured, three sheets of the images were output for every gradation, and the average value of the densities was determined to be the evaluation value. A correlation coefficient between the obtained evaluation values and the gradation steps was calculated, and the difference between the calculated correlation coefficient and a correlation coefficient obtained when the reflection densities of each gradation perfectly linearly change, which is 1.00, was determined. The gradation properties were evaluated by using a ratio of a difference calculated from the correlation coefficient of the electrophotographic photosensitive member which had been produced on each film-forming condition with respect to a difference calculated from the correlation coefficient in the electrophotographic photosensitive member which had been produced on the film-forming condition No. 2, as an indication of the gradation properties. In this evaluation method, the smaller is the numeric value, the more excellent are the gradation properties, which means that approximately linear gradation properties are obtained. In the evaluation, when the gradation properties were evaluated as class (A), the effect of the present invention was determined to be obtained.

Class (A) means that the ratio of the difference calculated by subtracting the correlation coefficient in the electrophotographic photosensitive member which had been produced on each film-forming condition from the correlation coefficient of 1.00, with respect to the difference calculated by subtracting the correlation coefficient in the electrophotographic photosensitive member which had been produced on the film-forming condition No. 2 from the correlation coefficient of 1.00 is 1.80 or smaller.

Class (B) means that the ratio of the difference calculated by subtracting the correlation coefficient in the electrophotographic photosensitive member which had been produced on each film-forming condition from the correlation coefficient of 1.00, with respect to the difference calculated by subtracting the correlation coefficient in the electrophotographic photosensitive member which had been produced on the film-forming condition No. 2 from the correlation coefficient of 1.00 is larger than 1.80.

(Evaluation for Sensitivity)

A remodeled machine was used for the evaluation, which was prepared by remodeling an electrophotographic apparatus iR-5065 (trade name) made by Canon Inc. so as to fit a negatively chargeable process and has a modified process speed of 300 mm/sec.

A produced electrophotographic photosensitive member was mounted in the electrophotographic apparatus, and the amount of an electric current to be supplied to the main charging assembly was controlled in a state of having turned the image-exposing light off so that the potential could be −500 V at the position of a developing apparatus at the center position in the longitudinal direction of the electrophotographic photosensitive member. After that, the image-exposing light was emitted, and the light quantity of the image-exposing light was controlled so that the potential at the position of the developing apparatus could be −100 V. The sensitivity was evaluated with the use of the light quantity of the image-exposing light set at that time. The light source for the image exposure in the electrophotographic apparatus which was used for the evaluation of the sensitivity was a semiconductor laser having the oscillation wavelength of 658 nm. The evaluation result was shown by a result of a relative comparison in which the light quantity of the image-exposing light in the case of having mounted the electrophotographic photosensitive member for the film-forming condition No. 6, which had been produced in Comparative Example 1, was considered as 1.00. In the evaluation, when the sensitivity was evaluated to be class (B) or higher, the effect of the present invention was determined to be obtained.

Class (A) means that the ratio of the light quantity of the image-exposing light with respect to the light quantity of the image-exposing light of the electrophotographic photosensitive member for the film-forming condition No. 6, which was produced in Comparative Example 1, is less than 1.10. Class (B) means that the ratio of the light quantity of the image-exposing light with respect to the light quantity of the image-exposing light of the electrophotographic photosensitive member for the film-forming condition No. 6, which was produced in Comparative Example 1, is 1.10 or more and less than 1.15. Class (C) means that the ratio of the light quantity of the image-exposing light with respect to the light quantity of the image-exposing light of the electrophotographic photosensitive member for the film-forming condition No. 6, which was produced in Comparative Example 1, is 1.15 or more. (Evaluation for ratio of sp³ structure)

The ratio of sp³ structure was evaluated by subjecting a sample obtained by cutting out the central portion in the longitudinal direction at an arbitrary point in a peripheral direction of the electrophotographic photosensitive member into a 10 mm square (10 mm×10 mm) to an analysis by a laser Raman spectrophotometer (NRS-2000 made by JASCO Corporation), and calculating the obtained result.

As for a specific measurement condition, a light source was set at Ar+laser 514.5 nm, a laser intensity was set at 20 mA, an object lens was set at 50 times, a center wavelength was set at 1380 cm⁻¹, an exposure time was set at 30 seconds, and the summation was set at 5 times. The measurement was carried out 3 times. The analysis method for the obtained Raman spectrum will be described below. The peak wave number of the shoulder Raman band was fixed at 1390 cm⁻¹, the peak wave number of the main Raman band was set at 1480 cm⁻¹ but was not fixed there, and the spectrum was subjected to curve fitting by using the Gaussian distribution. At this time, a straight line was used as a baseline for approximation. The ratio ID/IG was determined from the peak intensity IG of the main Raman band and the peak intensity ID of the shoulder Raman band which were obtained from the result of the curve fitting, and the average value of 3 times of measurements was used for the evaluation of the ratio of sp³ structure.

### Comparative Example 1

Two electrophotographic photosensitive members to be negatively charged were produced in the same method as in Example 1. However, a surface layer was formed on conditions shown in the following Table 3.

The produced electrophotographic photosensitive members to be negatively charged were evaluated in a similar way to that in Example 1.

These results are shown in Tables 5 and 6. In addition, the content of the boron atoms with respect to that of the silicon atoms in the upper charge injection inhibition layer was in the range of 300 atom ppm ±10 atom ppm, and the C/(Si+C) in the upper charge injection inhibition layer was in the range of 0.30±0.01.

TABLE 3

| Film-forming condition No. | 5 | 6 |
|---|---|---|
| SiH₄ [mL/min (normal)] | 26 | 26 |
| CH₄ [mL/min (normal)] | 500 | 1400 |
| Internal pressure (Pa) | 80 | 55 |
| High-frequency power (W) | 750 | 400 |
| Substrate temperature (° C.) | 290 | 260 |
| Film thickness (μm) | 0.5 | 0.5 |

### Comparative Example 2

Two electrophotographic photosensitive members to be negatively charged were produced in a similar way to that in Example 1, except that the surface layer formed from hydrogenated amorphous carbon was formed on conditions shown in the following Table 4.

The adhesiveness 1, the adhesiveness 2 and the sensitivity irregularity of the produced electrophotographic photosensitive members to be negatively charged were evaluated in a similar way to that in Example 1.

These results are shown in Table 6. In addition, the content of the boron atoms with respect to that of the silicon atoms in the upper charge injection inhibition layer was in the range of 300 atom ppm ±10 atom ppm, and the C/(Si+C) in the upper charge injection inhibition layer was in the range of 0.30±0.01.

TABLE 4

| Film-forming condition No. | 7 |
|---|---|
| SiH₄ [mL/min (normal)] | 0 |
| CH₄ [mL/min (normal)] | 600 |
| Internal pressure (Pa) | 55 |
| High-frequency power (W) | 1000 |
| Substrate temperature (° C.) | 260 |
| Film thickness (μm) | 0.5 |

TABLE 5

| | | Surface layer | | | | | | | | |
|---|---|---|---|---|---|---|---|---|---|---|
| | Film- | | Si atom | C atom | Si + C atom | | H atom | | | |
| | forming | | density | density | density | H | density | ratio of | | |
| | condition | C/ | (10²² | (10²² | (10²² | atom | (10²² | sp³ | Gradation | |
| | No. | (Si + C) | atoms/cm³) | atoms/cm³) | atoms/cm³) | ratio | atoms/cm³) | structure | properties | Sensitivity |
| Com. | 6 | 0.70 | 1.91 | 4.45 | 6.35 | 0.39 | 4.06 | 0.73 | A | A |
| Ex. 1 | 5 | 0.74 | 1.68 | 4.80 | 6.48 | 0.45 | 5.30 | 0.69 | A | A |
| Ex. 1 | 1 | 0.75 | 1.65 | 4.95 | 6.60 | 0.43 | 4.98 | 0.69 | A | A |
| | 2 | 0.73 | 1.81 | 4.88 | 6.69 | 0.44 | 5.26 | 0.67 | A | A |
| | 3 | 0.73 | 1.84 | 4.97 | 6.81 | 0.41 | 4.73 | 0.62 | A | A |
| | 4 | 0.72 | 1.93 | 4.97 | 6.90 | 0.41 | 4.79 | 0.70 | A | A |

TABLE 6

| | Film- | Durability number of sheets/A4 | | | | | | | | | | |
|---|---|---|---|---|---|---|---|---|---|---|---|---|
| | forming | Initial stage | | 250,000 sheets | | 500,000 sheets | | 750,000 sheets | | 1,000,000 sheets | | |
| | con- | Adhe- | | Adhe- | | Adhe- | | Adhe- | | Adhe- | | Adhe- |
| | dition | sive- | Sensitivity | sive- | Sensitivity | sive- | Sensitivity | sive- | Sensitivity | sive- | Sensitivity | sive- |
| | No. | ness 1 | irregularity | ness 1 | irregularity | ness 1 | irregularity | ness 1 | irregularity | ness 1 | irregularity | ness 2 |
| Com. | 6 | A | A | A | B | A | B | A | C | A | C | A |
| Ex. 1 | 5 | A | A | A | A | A | B | A | B | A | C | A |
| Ex. 1 | 1 | A | A | A | A | A | A | A | A | A | B | A |
| | 2 | A | A | A | A | A | A | A | A | A | B | A |
| | 3 | A | A | A | A | A | A | A | A | A | A | A |
| | 4 | A | A | A | A | A | A | A | A | A | A | A |
| Com. | 7 | A | A | B | — | B | — | C | — | D | — | D |
| Ex. 2 | | | | | | | | | | | | |

In Comparative Example 2 in which the a-C surface layer was formed on the upper charge injection inhibition layer formed from a-SiC, the film exfoliation partially occurred on the surface layer after 250,000 sheets of images were output in the evaluation test for adhesiveness. Accordingly, after that, the evaluation for the sensitivity irregularity could not be carried out, and the result was expressed by “-” in Table 6.

The followings were found from the results of Table 5 and Table 6.

It was found that though the electrophotographic photosensitive member in which the a-C surface layer was formed on the upper charge injection inhibition layer formed from a-SiC did not show an adequate result in the evaluation for the adhesiveness, the electrophotographic photosensitive member in which the a-SiC surface layer was formed as the surface layer did not cause the film exfoliation even after having been used for a long period of time. It was also found that the surface deterioration was suppressed and adequate sensitivity irregularity was kept by controlling the Si+C atom density of the surface layer to 6.60×10²² atoms/cm³ or more. Furthermore, it was found that the effect became further adequate by controlling the Si+C atom density to 6.81×10²² atoms/cm³ or more.

It was found from this result that an electrophotographic photosensitive member which was superior in the durability was obtained by controlling the Si+C atom density of the surface layer in the above described range.

### Example 2

Two electrophotographic photosensitive members to be negatively charged were produced in the same method as in Example 1, except that the surface layer was produced on conditions shown in the following Table 7.

The produced electrophotographic photosensitive members to be negatively charged were evaluated in a similar way to that in Example 1.

These results are shown in Table 9 and Table 10. In addition, the content of the boron atoms with respect to that of the silicon atoms in the upper charge injection inhibition layer was in the range of 300 atom ppm ±10 atom ppm, and the C/(Si+C) in the upper charge injection inhibition layer was in the range of 0.30±0.01.

TABLE 7

| Film-forming condition No. | 8 | 9 | 10 | 11 | 12 | 14 |
|---|---|---|---|---|---|---|
| SiH₄ [mL/min (normal)] | 35 | 26 | 26 | 26 | 26 | 26 |
| CH₄ [mL/min (normal)] | 190 | 150 | 190 | 400 | 360 | 400 |
| High-frequency power(W) | 750 | 700 | 700 | 800 | 850 | 900 |

### Comparative Example 3

Two electrophotographic photosensitive members to be negatively charged were produced in the same method as in Example 1, except that the surface layer was produced on conditions shown in the following Table 8.

The produced electrophotographic photosensitive members to be negatively charged were evaluated in a similar way to that in Example 1.

These results are shown in Table 9 and Table 10. In addition, the content of the boron atoms with respect to that of the silicon atoms in the upper charge injection inhibition layer was in the range of 300 atom ppm ±10 atom ppm, and the C/(Si+C) in the upper charge injection inhibition layer was in the range of 0.30±0.01.

TABLE 8

| Film-forming condition No. | 15 | 16 |
|---|---|---|
| SiH₄ [mL/min (normal)] | 35 | 26 |
| CH₄ [mL/min (normal)] | 190 | 450 |
| High-frequency power(W) | 700 | 950 |

TABLE 9

| | | Surface layer | | | | | | | | |
|---|---|---|---|---|---|---|---|---|---|---|
| | Film- | | Si atom | C atom | Si + C atom | | H atom | | | |
| | forming | | density | density | density | H | density | ratio of | | |
| | condition | C/ | (10²² | (10²² | (10²² | atom | (10²² | sp³ | Gradation | |
| | No. | (Si + C) | atoms/cm³) | atoms/cm³) | atoms/cm³) | ratio | atoms/cm³) | structure | properties | Sensitivity |
| Com. | 15 | 0.59 | 3.12 | 4.49 | 7.61 | 0.32 | 3.58 | 0.54 | B | A |
| Ex. 3 | | | | | | | | | | |
| Ex. 2 | 8 | 0.61 | 2.99 | 4.68 | 7.67 | 0.31 | 3.45 | 0.40 | A | A |
| | 9 | 0.63 | 2.90 | 4.94 | 7.84 | 0.30 | 3.36 | 0.50 | A | A |
| | 10 | 0.65 | 2.68 | 4.99 | 7.67 | 0.31 | 3.45 | 0.58 | A | A |
| | 11 | 0.73 | 1.85 | 5.02 | 6.87 | 0.40 | 4.58 | 0.63 | A | A |
| | 12 | 0.74 | 1.87 | 5.31 | 7.18 | 0.35 | 3.87 | 0.60 | A | A |
| | 14 | 0.75 | 1.79 | 5.37 | 7.16 | 0.36 | 4.03 | 0.63 | A | A |
| Com. | 16 | 0.76 | 1.74 | 5.49 | 7.23 | 0.34 | 3.72 | 0.66 | A | C |
| Ex. 3 | | | | | | | | | | |

TABLE 10

| | Film- | Durability number of sheets/A4 | | | | | | | | | | |
|---|---|---|---|---|---|---|---|---|---|---|---|---|
| | forming | Initial stage | | 250,000 sheets | | 500,000 sheets | | 750,000 sheets | | 1,000,000 sheets | | |
| | con- | Adhe- | | Adhe- | | Adhe- | | Adhe- | | Adhe- | | Adhe- |
| | dition | sive- | Sensitivity | sive- | Sensitivity | sive- | Sensitivity | sive- | Sensitivity | sive- | Sensitivity | sive- |
| | No. | ness 1 | irregularity | ness 1 | irregularity | ness 1 | irregularity | ness 1 | irregularity | ness 1 | irregularity | ness 2 |
| Com. | 15 | A | A | A | A | A | A | A | A | A | A | A |
| Ex. 3 | | | | | | | | | | | | |
| Ex. 2 | 8 | A | A | A | A | A | A | A | A | A | A | A |
| | 9 | A | A | A | A | A | A | A | A | A | A | A |
| | 10 | A | A | A | A | A | A | A | A | A | A | A |
| | 11 | A | A | A | A | A | A | A | A | A | A | A |
| | 12 | A | A | A | A | A | A | A | A | A | A | A |
| | 14 | A | A | A | A | A | A | A | A | A | A | A |
| Com. | 16 | A | A | A | A | A | A | A | A | A | A | A |
| Ex. 3 | | | | | | | | | | | | |

It was found from the results of Table 9 and Table 10 that gradation properties became adequate by controlling the Si+C atom density of the surface layer to 6.60×10²² atoms/cm³ or more, and controlling the C/(Si+C) to 0.61 or more. In addition, it was found that the light absorption was suppressed and the sensitivity became adequate by controlling the Si+C atom density of the surface layer to 6.60×10²² atoms/cm³ or more, and controlling the C/(Si+C) to 0.75 or less.

It was found from this result that an electrophotographic photosensitive member which suppressed the surface deterioration, kept adequate sensitivity irregularity, and was superior in the gradation properties and the sensitivity was obtained by controlling the Si+C atom density to 6.60×10²² atoms/cm³ or more, and controlling the C/(Si+C) in the surface layer to 0.61 or more and 0.75 or less.

### Example 3

Two electrophotographic photosensitive members to be negatively charged were produced in the same method as in Example 1, except that the surface layer was produced on conditions shown in the following Table 11.

The produced electrophotographic photosensitive members to be negatively charged were evaluated in a similar way to that in Example 1.

These results are shown in Table 12 and Table 13 together with the result of the film-forming condition No. 10 in Example 2. In addition, the content of the boron atoms with respect to that of the silicon atoms in the upper charge injection inhibition layer was in the range of 300 atom ppm ±10 atom ppm, and the C/(Si+C) in the upper charge injection inhibition layer was in the range of 0.30±0.01.

TABLE 11

| Film-forming condition No. | 17 | 18 | 19 | 20 | 21 | 22 | 23 | 24 | 25 |
|---|---|---|---|---|---|---|---|---|---|
| SiH₄ [mL/min (normal)] | 26 | 26 | 32 | 26 | 26 | 26 | 26 | 26 | 26 |
| CH₄ [mL/min (normal)] | 150 | 260 | 260 | 190 | 260 | 360 | 360 | 320 | 400 |
| High-frequency power (W) | 750 | 850 | 850 | 750 | 750 | 650 | 600 | 550 | 650 |

TABLE 12

| | | Surface layer | | | | | | | | |
|---|---|---|---|---|---|---|---|---|---|---|
| | Film- | | Si atom | C atom | Si + C atom | | H atom | | | |
| | forming | | density | density | density | H | density | ratio of | | |
| | condition | C/ | (10²² | (10²² | (10²² | atom | (10²² | sp³ | Gradation | |
| | No. | (Si + C) | atoms/cm³) | atoms/cm³) | atoms/cm³) | ratio | atoms/cm³) | structure | properties | Sensitivity |
| Ex. 3 | 17 | 0.65 | 2.78 | 5.15 | 7.93 | 0.28 | 3.08 | 0.34 | A | B |
| | 18 | 0.71 | 2.19 | 5.37 | 7.56 | 0.29 | 3.09 | 0.41 | A | B |
| | 19 | 0.67 | 2.48 | 5.04 | 7.52 | 0.30 | 3.22 | 0.31 | A | A |
| | 20 | 0.67 | 2.55 | 5.18 | 7.73 | 0.30 | 3.31 | 0.42 | A | A |
| Ex. 2 | 10 | 0.65 | 2.68 | 4.99 | 7.67 | 0.31 | 3.45 | 0.58 | A | A |
| Ex. 3 | 21 | 0.70 | 2.23 | 5.20 | 7.43 | 0.33 | 3.66 | 0.49 | A | A |
| | 22 | 0.71 | 1.96 | 4.81 | 6.77 | 0.42 | 4.90 | 0.78 | A | A |
| | 23 | 0.70 | 2.00 | 4.66 | 6.65 | 0.44 | 5.23 | 0.89 | A | A |
| | 24 | 0.68 | 2.14 | 4.54 | 6.68 | 0.45 | 5.47 | 0.96 | A | A |
| | 25 | 0.72 | 1.86 | 4.77 | 6.63 | 0.46 | 5.65 | 0.74 | A | A |

TABLE 13

| | | Durability number of sheets/A4 | | | | | | | | | | |
|---|---|---|---|---|---|---|---|---|---|---|---|---|
| | | Initial stage | | 250,000 sheets | | 500,000 sheets | | 750,000 sheets | | 1,000,000 sheets | | |
| | Film- | | Sensi- | | Sensi- | | Sensi- | | Sensi- | | Sensi- | |
| | forming | | tivity | | tivity | | tivity | | tivity | | tivity | |
| | condition | Adhesive- | irregu- | Adhesive- | irregu- | Adhesive- | irregu- | Adhesive- | irregu- | Adhesive- | irregu- | Adhesive- |
| | No. | ness 1 | larity | ness 1 | larity | ness 1 | larity | ness 1 | larity | ness 1 | larity | ness 2 |
| Ex. 3 | 17 | A | A | A | A | A | A | A | A | A | A | A |
| | 18 | A | A | A | A | A | A | A | A | A | A | A |
| | 19 | A | A | A | A | A | A | A | A | A | A | A |
| | 20 | A | A | A | A | A | A | A | A | A | A | A |
| Ex. 2 | 10 | A | A | A | A | A | A | A | A | A | A | A |
| Ex. 3 | 21 | A | A | A | A | A | A | A | A | A | A | A |
| | 22 | A | A | A | A | A | A | A | A | A | B | A |
| | 23 | A | A | A | A | A | A | A | A | A | B | A |
| | 24 | A | A | A | A | A | A | A | A | A | B | A |
| | 25 | A | A | A | A | A | B | A | B | A | B | A |

From the results of Table 12 and Table 13, it is understood that the light absorption was suppressed by controlling the H atom ratio of the surface layer to 0.30 or more, and the sensitivity was improved. In addition, by controlling the H atom ratio of the surface layer to 0.45 or less, the surface deterioration was further suppressed, and the sensitivity irregularity was improved.

It was found from this result that an electrophotographic photosensitive member which suppressed the surface deterioration, showed adequate sensitivity irregularity and was superior in the gradation properties and the sensitivity was obtained by controlling the Si+C atom density to 6.60×10²² atoms/cm³ or more, controlling the C/(Si+C) to 0.61 or more and 0.75 or less, and besides, setting the H atom ratio of the surface layer at the above described range.

### Example 4

Two electrophotographic photosensitive members to be negatively charged were produced in the same method as in Example 1, except that the surface layer was produced on conditions shown in the following Table 14.

The produced electrophotographic photosensitive members to be negatively charged were evaluated in a similar way to that in Example 1.

These results are shown in Table 15 and Table 16 together with the results of the film-forming condition No. 4 in Example 1 and the film-forming conditions No. 9 and 11 in Example 2. In addition, the content of the boron atoms with respect to that of the silicon atoms in the upper charge injection inhibition layer was in the range of 300 atom ppm ±10 atom ppm, and the C/(Si+C) in the upper charge injection inhibition layer was in the range of 0.30±0.01.

TABLE 14

| Film-forming condition No. | 17 | 18 | 19 | 20 | 21 | 22 | 23 | 24 | 25 |
|---|---|---|---|---|---|---|---|---|---|
| SiH₄ [mL/min (normal)] | 26 | 26 | 32 | 26 | 26 | 26 | 26 | 26 | 26 |
| CH₄ [mL/min (normal)] | 150 | 260 | 260 | 190 | 260 | 360 | 360 | 320 | 400 |
| High-frequency power (W) | 750 | 850 | 850 | 750 | 750 | 650 | 600 | 550 | 650 |

TABLE 15

| | | Surface layer | | | | | | | | |
|---|---|---|---|---|---|---|---|---|---|---|
| | Film- | | Si atom | C atom | Si + C atom | | H atom | | | |
| | forming | | density | density | density | H | density | ratio of | | |
| | condition | C/ | (10²² | (10²² | (10²² | atom | (10²² | sp³ | Gradation | |
| | No. | (Si + C) | atoms/cm³) | atoms/cm³) | atoms/cm³) | ratio | atoms/cm³) | structure | properties | Sensitivity |
| Ex. 4 | 26 | 0.67 | 2.63 | 5.35 | 7.98 | 0.25 | 2.66 | 0.20 | A | B |
| | 27 | 0.66 | 2.70 | 5.24 | 7.94 | 0.27 | 2.94 | 0.25 | A | B |
| | 28 | 0.68 | 2.51 | 5.33 | 7.84 | 0.27 | 2.90 | 0.30 | A | B |
| | 29 | 0.67 | 2.57 | 5.22 | 7.79 | 0.29 | 3.18 | 0.33 | A | B |
| Ex. 2 | 9 | 0.63 | 2.90 | 4.94 | 7.84 | 0.30 | 3.36 | 0.50 | A | A |
| | 11 | 0.73 | 1.85 | 5.02 | 6.87 | 0.40 | 4.58 | 0.63 | A | A |
| Ex. 4 | 30 | 0.71 | 2.04 | 5.00 | 7.04 | 0.39 | 4.50 | 0.63 | A | A |
| Ex. 1 | 4 | 0.72 | 1.93 | 4.97 | 6.90 | 0.41 | 4.79 | 0.70 | A | A |
| Ex. 4 | 31 | 0.70 | 2.09 | 4.87 | 6.96 | 0.41 | 4.84 | 0.72 | A | A |
| | 32 | 0.68 | 2.22 | 4.71 | 6.93 | 0.42 | 5.02 | 0.86 | A | A |

TABLE 16

| | | Durability number of sheets/A4 | | | | | | | | | | |
|---|---|---|---|---|---|---|---|---|---|---|---|---|
| | | Initial stage | | 250,000 sheets | | 500,000 sheets | | 750,000 sheets | | 1,000,000 sheets | | |
| | Film- | | Sensi- | | Sensi- | | Sensi- | | Sensi- | | Sensi- | |
| | forming | | tivity | | tivity | | tivity | | tivity | | tivity | |
| | condition | Adhesive- | irregu- | Adhesive- | irregu- | Adhesive- | irregu- | Adhesive- | irregu- | Adhesive- | irregu- | Adhesive- |
| | No. | ness 1 | larity | ness 1 | larity | ness 1 | larity | ness 1 | larity | ness 1 | larity | ness 2 |
| Ex. 4 | 26 | A | A | A | A | A | A | A | A | A | A | A |
| | 27 | A | A | A | A | A | A | A | A | A | A | A |
| | 28 | A | A | A | A | A | A | A | A | A | A | A |
| | 29 | A | A | A | A | A | A | A | A | A | A | A |
| Ex. 2 | 9 | A | A | A | A | A | A | A | A | A | A | A |
| | 11 | A | A | A | A | A | A | A | A | A | A | A |
| Ex. 4 | 30 | A | A | A | A | A | A | A | A | A | A | A |
| Ex. 1 | 4 | A | A | A | A | A | A | A | A | A | A | A |
| Ex. 4 | 31 | A | A | A | A | A | A | A | A | A | B | A |
| | 32 | A | A | A | A | A | A | A | A | A | B | A |

It was found from the results of Table 15 and Table 16 that an electrophotographic apparatus which further suppressed the surface deterioration and was superior in the durability was obtained by controlling the ratio of sp³ structure of the surface layer in the range of 0.20 or more and 0.70 or less.

### Comparative Example 4

Two electrophotographic photosensitive members to be negatively charged were produced in the same method as in Example 1, except that the surface layer was produced on conditions shown in the following Table 17.

The produced electrophotographic photosensitive members to be negatively charged were evaluated in a similar way to that in Example 1.

These results are shown in Table 18 and Table 19 together with the results of the film-forming condition No. 4 in Example 1, the film-forming condition No. 12 in Example 2 and the film-forming conditions No. 22 and 23 in Example 3. In addition, the content of the boron atoms with respect to that of the silicon atoms in the upper charge injection inhibition layer was in the range of 300 atom ppm ±10 atom ppm, and the C/(Si+C) in the upper charge injection inhibition layer was in the range of 0.30±0.01.

TABLE 17

| Film-forming condition No. | 33 | 34 | 35 | 36 |
|---|---|---|---|---|
| SiH₄ [mL/min (normal)] | 26 | 26 | 20 | 20 |
| CH₄ [mL/min (normal)] | 360 | 360 | 600 | 600 |
| High-frequency power (W) | 550 | 1000 | 750 | 850 |

TABLE 18

| | | Surface layer | | | | | | | | |
|---|---|---|---|---|---|---|---|---|---|---|
| | Film- | | Si atom | C atom | Si + C atom | | H atom | | | |
| | forming | | density | density | density | H | density | ratio of | | |
| | condition | C/ | (10²² | (10²² | (10²² | atom | (10²² | sp³ | Gradation | |
| | No. | (Si + C) | atoms/cm³) | atoms/cm³) | atoms/cm³) | ratio | atoms/cm³) | structure | properties | Sensitivity |
| Com. Ex. 4 | 33 | 0.69 | 2.02 | 4.49 | 6.50 | 0.46 | 5.54 | 0.96 | A | A |
| Ex. 3 | 23 | 0.70 | 2.00 | 4.66 | 6.65 | 0.44 | 5.23 | 0.89 | A | A |
| | 22 | 0.71 | 1.96 | 4.81 | 6.77 | 0.42 | 4.90 | 0.78 | A | A |
| Ex. 1 | 4 | 0.72 | 1.93 | 4.97 | 6.90 | 0.41 | 4.79 | 0.70 | A | A |
| Ex. 2 | 12 | 0.74 | 1.87 | 5.31 | 7.18 | 0.37 | 4.22 | 0.60 | A | A |
| Com. Ex. 4 | 34 | 0.76 | 1.78 | 5.64 | 7.42 | 0.29 | 3.03 | 0.67 | A | C |
| | 35 | 0.77 | 1.45 | 4.85 | 6.30 | 0.46 | 5.37 | 0.75 | A | C |
| | 36 | 0.79 | 1.37 | 5.15 | 6.52 | 0.44 | 5.12 | 0.77 | A | C |

TABLE 19

| | | Durability number of sheets/A4 | | | | | | | | | | |
|---|---|---|---|---|---|---|---|---|---|---|---|---|
| | | Initial stage | | 250,000 sheets | | 500,000 sheets | | 750,000 sheets | | 1,000,000 sheets | | |
| | Film- | | Sensi- | | Sensi- | | Sensi- | | Sensi- | | Sensi- | |
| | forming | | tivity | | tivity | | tivity | | tivity | | tivity | |
| | condition | Adhesive- | irregu- | Adhesive- | irregu- | Adhesive- | irregu- | Adhesive- | irregu- | Adhesive- | irregu- | Adhesive- |
| | No. | ness 1 | larity | ness 1 | larity | ness 1 | larity | ness 1 | larity | ness 1 | larity | ness 2 |
| Com. Ex. 4 | 33 | A | A | A | A | A | A | A | B | A | C | A |
| Ex. 3 | 23 | A | A | A | A | A | A | A | A | A | B | A |
| | 22 | A | A | A | A | A | A | A | A | A | B | A |
| Ex. 1 | 4 | A | A | A | A | A | A | A | A | A | A | A |
| Ex. 2 | 12 | A | A | A | A | A | A | A | A | A | A | A |
| Com. Ex. 4 | 34 | A | A | A | A | A | A | A | A | A | A | A |
| | 35 | A | A | A | A | A | B | A | C | A | C | A |
| | 36 | A | A | A | A | A | A | A | B | A | C | A |

It was found from the results of Table 18 and 19 that an electrophotographic photosensitive member which suppressed the surface deterioration, kept adequate sensitivity irregularity, and was superior in the adhesiveness, the gradation properties and the sensitivity was obtained by controlling the Si+C atom density of the surface layer to 6.60×10²² atoms/cm³ or more, and controlling the C/(Si+C) to 0.61 or more and 0.75 or less.

As a result, it was found that such an electrophotographic photosensitive member was obtained as to be capable of suppressing the deterioration in the surface of the a-SiC surface layer and superior in the sensitivity irregularity, the adhesiveness, the gradation properties, the sensitivity and characteristics of the electrophotographic photosensitive member even when having been used for a long period of time, in the range of the present invention.

### Example 5

Two electrophotographic photosensitive members to be negatively charged were produced in the same method as in Example 1, except that the surface layer was produced on conditions shown in the following Table 20.

The produced electrophotographic photosensitive members to be negatively charged were evaluated in a similar way to that in Example 1.

These results are shown in Table 22 and Table 23 together with the results of the film-forming condition No. 8 in Example 2, the film-forming condition No. 15 in Comparative Example 3 and the film-forming conditions No. 18, 19 and 21 in Example 3. In addition, the content of the boron atoms with respect to that of the silicon atom in the upper charge injection inhibition layer was in the range of 300 atom ppm ±10 atom ppm, and the C/(Si+C) in the upper charge injection inhibition layer was in the range of 0.30±0.01.

TABLE 20

| Film-forming condition No. | 37 | 38 |
|---|---|---|
| SiH₄ [mL/min (normal)] | 32 | 35 |
| CH₄ [mL/min (normal)] | 260 | 190 |
| High-frequency power (W) | 650 | 900 |

### Comparative Example 5

Two electrophotographic photosensitive members to be negatively charged were produced in the same method as in Example 1, except that the surface layer was produced on conditions shown in the following Table 21.

The produced electrophotographic photosensitive members to be negatively charged were evaluated in a similar way to that in Example 1.

These results are shown in Table 22 and Table 23 together with the results of the film-forming condition No. 8 in Example 5 and Example 2, the film-forming condition No. 15 in Comparative Example 3 and the film-forming conditions No. 18, 19 and 21 in Example 3. In addition, the content of the boron atoms with respect to that of the silicon atoms in the upper charge injection inhibition layer was in the range of 300 atom ppm ±10 atom ppm, and the C/(Si+C) in the upper charge injection inhibition layer was in the range of 0.30±0.01.

TABLE 21

| Film-forming condition No. | 39 | 40 | 41 |
|---|---|---|---|
| SiH₄ [mL/min (normal)] | 26 | 32 | 35 |
| CH₄ [mL/min (normal)] | 260 | 260 | 190 |
| High-frequency power (W) | 400 | 450 | 550 |

TABLE 22

| | | Surface layer | | | | | | | | |
|---|---|---|---|---|---|---|---|---|---|---|
| | Film- | | Si atom | C atom | Si + C atom | | H atom | | | |
| | forming | | density | density | density | H | density | ratio of | | |
| | condition | C/ | (10²² | (10²² | (10²² | atom | (10²² | sp³ | Gradation | |
| | No. | (Si + C) | atoms/cm³) | atoms/cm³) | atoms/cm³) | ratio | atoms/cm³) | structure | properties | Sensitivity |
| Com. Ex. 5 | 39 | 0.63 | 2.42 | 4.12 | 6.54 | 0.49 | 6.28 | 1.46 | A | A |
| Ex. 3 | 21 | 0.70 | 2.23 | 5.20 | 7.43 | 0.33 | 3.66 | 0.49 | A | A |
| | 18 | 0.71 | 2.19 | 5.37 | 7.56 | 0.29 | 3.09 | 0.41 | A | B |
| Com. Ex. 5 | 40 | 0.60 | 2.68 | 4.02 | 6.70 | 0.44 | 5.26 | 1.27 | B | A |
| Ex. 5 | 37 | 0.64 | 2.61 | 4.64 | 7.25 | 0.38 | 4.44 | 0.69 | A | A |
| Ex. 3 | 19 | 0.67 | 2.48 | 5.04 | 7.52 | 0.30 | 3.22 | 0.31 | A | A |
| Com. Ex. 5 | 41 | 0.56 | 3.21 | 4.09 | 7.30 | 0.39 | 4.67 | 1.80 | B | A |
| Com. Ex. 3 | 15 | 0.59 | 3.12 | 4.49 | 7.61 | 0.32 | 3.58 | 0.54 | B | A |
| Ex. 2 | 8 | 0.61 | 2.99 | 4.68 | 7.67 | 0.31 | 3.45 | 0.40 | A | A |
| Ex. 5 | 38 | 0.64 | 2.83 | 5.03 | 7.86 | 0.27 | 2.91 | 0.21 | A | B |

TABLE 23

| | | Durability number of sheets/A4 | | | | | | | | | | |
|---|---|---|---|---|---|---|---|---|---|---|---|---|
| | | Initial stage | | 250,000 sheets | | 500,000 sheets | | 750,000 sheets | | 1,000,000 sheets | | |
| | Film- | | Sensi- | | Sensi- | | Sensi- | | Sensi- | | Sensi- | |
| | forming | | tivity | | tivity | | tivity | | tivity | | tivity | |
| | condition | Adhesive- | irregu- | Adhesive- | irregu- | Adhesive- | irregu- | Adhesive- | irregu- | Adhesive- | irregu- | Adhesive- |
| | No. | ness 1 | larity | ness 1 | larity | ness 1 | larity | ness 1 | larity | ness 1 | larity | ness 2 |
| Com. Ex. 5 | 39 | A | A | A | A | A | B | A | C | A | C | A |
| Ex. 3 | 21 | A | A | A | A | A | A | A | A | A | A | A |
| | 18 | A | A | A | A | A | A | A | A | A | A | A |
| Com. Ex. 5 | 40 | A | A | A | A | A | A | A | B | A | B | A |
| Ex. 5 | 37 | A | A | A | A | A | A | A | A | A | A | A |
| Ex. 3 | 19 | A | A | A | A | A | A | A | A | A | A | A |
| Com. Ex. 5 | 41 | A | A | A | A | A | A | A | A | A | B | A |
| Com. Ex. 3 | 15 | A | A | A | A | A | A | A | A | A | A | A |
| Ex. 2 | 8 | A | A | A | A | A | A | A | A | A | A | A |
| Ex. 5 | 38 | A | A | A | A | A | A | A | A | A | A | A |

It was found from the results of Table 22 and Table 23 that an electrophotographic photosensitive member which suppressed the surface deterioration, showed adequate sensitivity irregularity and was superior in the adhesiveness, the gradation properties and the sensitivity was obtained by controlling the Si+C atom density of the surface layer to 6.60×10²² atoms/cm³ or more, and controlling the C/(Si+C) to 0.61 or more and 0.75 or less.

As a result, it was found that such an electrophotographic photosensitive member was obtained as to be capable of suppressing the deterioration in the surface of the a-SiC surface layer and superior in the adhesiveness, the gradation properties, the sensitivity and characteristics of the electrophotographic photosensitive member even when having been used for a long period of time, in the range of the present invention.

### Comparative Example 6

Two electrophotographic photosensitive members to be negatively charged were produced in the same method as in Example 1, except that the surface layer was produced on conditions shown in the following Table 24.

The produced electrophotographic photosensitive members to be negatively charged were evaluated in a similar way to that in Example 1.

These results are shown in Table 25 and Table 26 together with the results of the film-forming condition No. 1 in Example 1, the film-forming condition No. 11 in Example 2 and the film-forming conditions No. 27 and 29 in Example 4.

In addition, the content of the boron atoms with respect to that of the silicon atoms in the upper charge injection inhibition layer was in the range of 300 atom ppm ±10 atom ppm, and the C/(Si+C) in the upper charge injection inhibition layer was in the range of 0.30±0.01.

TABLE 24

| Film-forming condition No. | 42 |
|---|---|
| SiH4 [mL/min (normal)] | 26 |
| CH₄ [mL/min (normal)] | 700 |
| High-frequency power (W) | 800 |

TABLE 25

| | | Surface layer | | | | | | | | |
|---|---|---|---|---|---|---|---|---|---|---|
| | Film- | | Si atom | C atom | Si + C atom | | H atom | | | |
| | forming | | density | density | density | H | density | ratio of | | |
| | condition | C/ | (10²² | (10²² | (10²² | atom | (10²² | sp³ | Gradation | |
| | No. | (Si + C) | atoms/cm³) | atoms/cm³) | atoms/cm³) | ratio | atoms/cm³) | structure | properties | Sensitivity |
| Com. Ex. 6 | 42 | 0.77 | 1.41 | 4.7 | 6.11 | 0.48 | 5.64 | 0.78 | A | C |
| Ex. 1 | 1 | 0.75 | 1.65 | 4.95 | 6.60 | 0.43 | 4.98 | 0.69 | A | A |
| Ex. 2 | 11 | 0.73 | 1.85 | 5.02 | 6.87 | 0.40 | 4.58 | 0.63 | A | A |
| Ex. 4 | 29 | 0.67 | 2.57 | 5.22 | 7.79 | 0.29 | 3.18 | 0.33 | A | B |
| | 27 | 0.66 | 2.70 | 5.24 | 7.94 | 0.27 | 2.94 | 0.25 | A | B |

TABLE 26

| | | Durability number of sheets/A4 | | | | | | | | | | |
|---|---|---|---|---|---|---|---|---|---|---|---|---|
| | | Initial stage | | 250,000 sheets | | 500,000 sheets | | 750,000 sheets | | 1,000,000 sheets | | |
| | Film- | | Sensi- | | Sensi- | | Sensi- | | Sensi- | | Sensi- | |
| | forming | | tivity | | tivity | | tivity | | tivity | | tivity | |
| | condition | Adhesive- | irregu- | Adhesive- | irregu- | Adhesive- | irregu- | Adhesive- | irregu- | Adhesive- | irregu- | Adhesive- |
| | No. | ness 1 | larity | ness 1 | larity | ness 1 | larity | ness 1 | larity | ness 1 | larity | ness 2 |
| Com. Ex. 6 | 42 | A | A | A | A | A | B | A | C | A | C | A |
| Ex. 1 | 1 | A | A | A | A | A | A | A | A | A | B | A |
| Ex. 2 | 11 | A | A | A | A | A | A | A | A | A | A | A |
| Ex. 4 | 29 | A | A | A | A | A | A | A | A | A | A | A |
| | 27 | A | A | A | A | A | A | A | A | A | A | A |

It was found from the results of Table 25 and Table 26 that an electrophotographic photosensitive member which was superior in the adhesiveness, the sensitivity irregularity, the gradation properties and the sensitivity was obtained by controlling the Si+C atom density of the surface layer to 6.60×10²² atoms/cm³ or more, and controlling the C/(Si+C) to 0.61 or more and 0.75 or less.

As a result, it was found that such an electrophotographic photosensitive member was obtained as to be capable of suppressing the deterioration in the surface of the a-SiC surface layer and superior in the adhesiveness, the gradation properties, the sensitivity and characteristics of the electrophotographic photosensitive member even when having been used for a long period of time, in the range of the present invention.

### Example 6

An electrophotographic photosensitive member to be negatively charged was produced on a cylindrical substrate (cylindrical substrate made from aluminum, which had a diameter of 80 mm, a length of 358 mm and a thickness of 3 mm, and was mirror-finished) by using a plasma treatment apparatus which is illustrated in FIG. 2 and uses a high-frequency power source that employs RF bands as a frequency, according to the following conditions shown in Table 27. At this time, a lower charge injection inhibition layer, a photoconductive layer, an upper charge injection inhibition layer and a surface layer were formed in this order, and when the upper charge injection inhibition layer was produced, a high-frequency electric power and the flow rate of each gas were set at conditions shown in Table 28. In addition, two electrophotographic photosensitive members to be negatively charged were produced for each film-forming condition. In addition, the forming condition for the surface layer is the same as the film-forming condition No. 4 in Example 1, and the surface layer to be formed has characteristics specified in the range of the present invention.

The C/(Si+C), the content of boron atoms, the adhesiveness, the sensitivity irregularity and the gradation properties of the upper charge injection inhibition layer in the produced electrophotographic photosensitive member to be negatively charged were determined in the same method as in Example 1, and the charging ability was evaluated in the method which will be described below.

These results are shown in Table 30 together with the results of the film-forming condition No. 4 in Example 1, and Comparative Example 7. In addition, the content of the boron atoms with respect to that of the silicon atoms in the upper charge injection inhibition layer was in the range of 300 atom ppm ±10 atom ppm in the film-forming conditions No. 43 to 46, was 30,000 atom ppm in the film-forming condition No. 70, and was 10 atom ppm in the film-forming condition No. 71.

TABLE 27

| | Lower | | Upper | |
|---|---|---|---|---|
| | charge | | charge | |
| | injection | Photo- | injection | |
| | inhibition | conductive | inhibition | Surface |
| | layer | layer | layer | layer |
| Type of gas and flow rate | | | | |
| SiH₄ [mL/min (normal)] | 350 | 450 | * | 26 |
| H₂ [mL/min (normal)] | 750 | 2200 | | |
| PH₃ [ppm] (vs. SiH₄) | 1500 | | | |
| B₂H₆ [ppm] (vs. SiH₄) | | | * | |
| NO [mL/min (normal)] | 10 | | | |
| CH₄ [mL/min (normal)] | | | * | 360 |
| Internal pressure [Pa] | 40 | 80 | 55 | 80 |
| High-frequency power [W] | 400 | 900 | * | 700 |
| Substrate temperature [° C.] | 260 | 260 | 260 | 290 |
| Film thickness [μm] | 3.3 | 25 | 0.2 | 0.5 |

TABLE 28

| Film-forming condition No. | 43 | 44 | 45 | 46 | 70 | 71 |
|---|---|---|---|---|---|---|
| SiH₄ [mL/min (normal)] | 950 | 250 | 10 | 10 | 950 | 10 |
| B₂H₆ [ppm] (vs. SiH₄) | 765 | 785 | 850 | 940 | 31000 | 30 |
| CH₄ [mL/min (normal)] | 5 | 51 | 190 | 390 | 5 | 390 |
| Internal pressure [Pa] | 55 | 55 | 55 | 55 | 55 | 55 |
| High-frequency power [W] | 100 | 300 | 600 | 800 | 100 | 800 |
| Substrate temperature [° C.] | 260 | 260 | 260 | 260 | 260 | 260 |
| Film thickness [μm] | 0.2 | 0.2 | 0.2 | 0.2 | 0.2 | 0.2 |

A remodeled machine was used for the evaluation, which was prepared by remodeling an electrophotographic apparatus iR-5065 (trade name) made by Canon Inc. so as to fit a negatively chargeable process and has a modified process speed of 300 mm/sec.

The amount of an electric current to be applied to the main charging assembly was controlled to −1,600 μA in a state of having turned the image exposure off, the surface potential of the electrophotographic photosensitive member at the position of a developing apparatus at the central portion in the longitudinal direction of the electrophotographic photosensitive member was measured, and the value of the surface potential was determined to be the charging ability.

The evaluation result was shown by a result of a relative comparison in which the charging ability in the case of having mounted the electrophotographic photosensitive member for the film-forming condition No. 4, which had been produced in Example 1, was considered as 1.00. When having been evaluated to be class (A) or (B), the charging ability was determined to be adequate. Class (A) means that the ratio of the charging ability of the evaluated photosensitive member with respect to the charging ability of the electrophotographic photosensitive member on the film-forming condition No. 4, which was produced in Example 1, is 1.20 or more. Class (B) means that the ratio of the charging ability of the evaluated photosensitive member with respect to the charging ability of the electrophotographic photosensitive member on the film-forming condition No. 4, which was produced in Example 1, is 0.95 or more and less than 1.20.

Class (C) means that the ratio of the charging ability of the evaluated photosensitive member with respect to the charging ability of the electrophotographic photosensitive member on the film-forming condition No. 4, which was produced in Example 1, is less than 0.95.

### Comparative Example 7

Two electrophotographic photosensitive members to be negatively charged were produced in the same method as in Example 6, except that the upper charge injection inhibition layer was produced on conditions shown in the following Table 29.

The produced electrophotographic photosensitive members to be negatively charged were evaluated in a similar way to that in Example 6.

These results are shown in Table 30 together with the results of the film-forming condition No. 4 in Example 1, and Example 6. In addition, the C/(Si+C) in the surface layer was in a range of 0.72±0.01, the Si+C atom density was in a range of (6.90 ±0.02)×10²² atoms/cm³, and the H atom ratio was in a range of 0.41±0.01. The content of the boron atoms with respect to that of the silicon atoms in the upper charge injection inhibition layer was in a range of 300 atom ppm ±10 atom ppm.

TABLE 29

| Film-forming condition No. | 47 | 48 |
|---|---|---|
| SiH₄ [mL/min (normal)] | 950 | 10 |
| B₂H₆ [ppm] (vs. SiH₄) | 765 | 955 |
| CH₄ [mL/min (normal)] | 3 | 430 |
| Internal pressure [Pa] | 55 | 55 |
| High-frequency power [W] | 100 | 800 |
| Substrate temperature [° C.] | 260 | 260 |
| Film thickness [μm] | 0.2 | 0.2 |

TABLE 30

| | | | Durability number of sheets/A4 | | | | | |
|---|---|---|---|---|---|---|---|---|
| | | | Initial stage | | 250,000 sheets | | 500,000 sheets | |
| | Film-forming | C/ | Adhesive- | Sensitivity | Adhesive- | Sensitivity | Adhesive- | Sensitivity |
| | condition No. | (Si + C) | ness 1 | irregularity | ness 1 | irregularity | ness 1 | irregularity |
| Com. Ex. 7 | 47 | 0.09 | A | A | A | A | A | A |
| Ex. 6 | 70 | 0.10 | A | A | A | A | A | A |
| | 43 | 0.10 | A | A | A | A | A | A |
| | 44 | 0.21 | A | A | A | A | A | A |
| Ex. 1 | 4 | 0.30 | A | A | A | A | A | A |
| Ex. 6 | 45 | 0.52 | A | A | A | A | A | A |
| | 46 | 0.60 | A | A | A | A | A | A |
| | 71 | 0.60 | A | A | A | A | A | A |
| Com. Ex. 7 | 48 | 0.61 | A | A | A | A | A | A |

| | Durability number of sheets/A4 | | | | | | |
|---|---|---|---|---|---|---|---|
| | 750,000 sheets | | 1,000,000 sheets | | | | |
| | Adhesive- | Sensitivity | Adhesive- | Sensitivity | Adhesive- | Gradation | Gradation |
| | ness 1 | irregularity | ness 1 | irregularity | ness 2 | properties | properties |
| Com. Ex. 7 | A | A | A | A | A | A | B |
| Ex. 6 | A | A | A | A | A | A | A |
| | A | A | A | A | A | A | A |
| | A | A | A | A | A | A | A |
| Ex. 1 | A | A | A | A | A | A | A |
| Ex. 6 | A | A | A | A | A | A | A |
| | A | A | A | A | A | B | A |
| | A | A | A | A | A | B | A |
| Com. Ex. 7 | A | A | A | A | A | C | A |

It was found from the result in Table 30 that the charging ability and the gradation properties were adequately kept by controlling the C/(Si+C) in the upper charge injection inhibition layer to 0.10 or more and 0.60 or less. It was also confirmed that an electrophotographic photosensitive member was obtained in which the surface deterioration was suppressed, the sensitivity irregularity was adequately kept, and was superior in the adhesiveness, the gradation properties and the charging ability.

### Example 7

Two electrophotographic photosensitive members to be negatively charged were produced in the same method as in Example 6, except that the upper charge injection inhibition layer was produced on conditions shown in the following Table 31. In addition, the forming condition for the surface layer is the same as the film-forming condition No. 4 in Example 1, and the surface layer to be formed has characteristics specified in the range of the present invention.

The produced electrophotographic photosensitive members to be negatively charged were evaluated in a similar way to that in Example 6.

These results are shown in Table 33 together with the results of the film-forming condition No. 4 in Example 1, and Comparative Example 8. In addition, the C/(Si+C) in the upper charge injection inhibition layer was in a range of 0.30±0.01.

TABLE 31

| Film-forming condition No. | 49 | 50 | 51 | 52 |
|---|---|---|---|---|
| SiH₄ [mL/min (normal)] | 250 | 250 | 250 | 250 |
| B₂H₆ [ppm] (vs. SiH₄) | 30 | 450 | 5800 | 31000 |
| CH₄ [mL/min (normal)] | 310 | 310 | 310 | 310 |
| Internal pressure [Pa] | 55 | 55 | 55 | 55 |
| High-frequency power[W] | 400 | 400 | 400 | 400 |
| Substrate temperature[° C.] | 260 | 260 | 260 | 260 |
| Film thickness[μm] | 0.2 | 0.2 | 0.2 | 0.2 |

### Comparative Example 8

Two electrophotographic photosensitive members to be negatively charged were produced in the same method as in Example 6, except that the upper charge injection inhibition layer was produced on conditions shown in the following Table 32.

The produced electrophotographic photosensitive members to be negatively charged were evaluated in a similar way to that in Example 6.

These results are shown in Table 33 together with the results of the film-forming condition No. 4 in Example 1, and Example 7. In addition, the C/(Si+C) in the upper charge injection inhibition layer was in a range of 0.30±0.01.

TABLE 32

| Film-forming condition No. | 53 | 54 |
|---|---|---|
| SiH₄ [mL/min (normal)] | 250 | 250 |
| B₂H₆ [ppm] (vs. SiH₄) | 15 | 36000 |
| CH₄ [mL/min (normal)] | 310 | 310 |
| Internal pressure [Pa] | 55 | 55 |
| High-frequency power [W] | 400 | 400 |
| Substrate temperature [° C.] | 260 | 260 |
| Film thickness [μm] | 0.2 | 0.2 |

TABLE 33

| | | | Durability number of sheets/A4 | | | | | |
|---|---|---|---|---|---|---|---|---|
| | | | Initial stage | | 250,000 sheets | | 500,000 sheets | |
| | Film-forming | Boron content | Adhesive- | Sensitivity | Adhesive- | Sensitivity | Adhesive- | Sensitivity |
| | condition No. | (ppm) | ness 1 | irregularity | ness 1 | irregularity | ness 1 | irregularity |
| Com. Ex. 8 | 53 | 5 | A | A | A | A | A | A |
| Ex. 7 | 49 | 10 | A | A | A | A | A | A |
| | 50 | 150 | A | A | A | A | A | A |
| Ex. 1 | 4 | 300 | A | A | A | A | A | A |
| Ex. 7 | 51 | 3000 | A | A | A | A | A | A |
| | 52 | 30000 | A | A | A | A | A | A |
| Com. Ex. 8 | 54 | 35000 | A | A | A | A | A | A |

| | Durability number of sheets/A4 | | | | | | |
|---|---|---|---|---|---|---|---|
| | 750,000 sheets | | 1,000,000 sheets | | | | |
| | Adhesive- | Sensitivity | Adhesive- | Sensitivity | Adhesive- | Gradation | Gradation |
| | ness 1 | irregularity | ness 1 | irregularity | ness 2 | properties | properties |
| Com. Ex. 8 | A | A | A | A | A | D | A |
| Ex. 7 | A | A | A | A | A | B | A |
| | A | A | A | A | A | A | A |
| Ex. 1 | A | A | A | A | A | A | A |
| Ex. 7 | A | A | A | A | A | A | A |
| | A | A | A | A | A | A | A |
| Com. Ex. 8 | A | A | A | A | A | A | B |

It was found from the result of Table 33 that the charging ability and the gradation properties were adequately kept by controlling the content of the boron atoms which were the Group 13 atom of the Periodic Table with respect to that of the silicon atoms in the upper charge injection inhibition layer to 10 atom ppm or more and 30,000 atom ppm or less. It was also confirmed that an electrophotographic photosensitive member was obtained in which the surface deterioration was suppressed, the sensitivity irregularity was adequately kept, and was superior in the adhesiveness, the gradation properties and the charging ability.

### Example 8

An electrophotographic photosensitive member to be positively charged was produced on a cylindrical substrate (cylindrical substrate made from aluminum, which had a diameter of 80 mm, a length of 358 mm and a thickness of 3 mm, and was mirror-finished) by using a plasma treatment apparatus which is illustrated in FIG. 2 and uses a high-frequency power source that employs RF bands as a frequency, according to the following conditions shown in Table 34. At this time, the upper charge injection inhibition layer was formed on conditions shown in the following Table 35. In addition, two electrophotographic photosensitive members to be positively charged were produced for each film-forming condition. In addition, the forming condition for the surface layer is the same as the film-forming condition No. 4 in Example 1, and the surface layer to be formed has characteristics specified in the range of the present invention.

The C/(Si+C), the adhesiveness, the sensitivity irregularity and the gradation properties of the upper charge injection inhibition layer in the produced electrophotographic photosensitive members to be positively charged were determined in the same method as in Example 1, and the charging ability was evaluated in the method which will be described below.

In addition, when the adhesiveness, the sensitivity irregularity and the gradation properties were evaluated, the evaluation machine was not changed to a type for negative electrification but was used as in the type for positive electrification.

In addition, the content of phosphorus atoms with respect to that of the silicon atoms in the upper charge injection inhibition layer was measured with SIMS (secondary ion mass spectrometry) (product made by CAMECA SAS, trade name: IMS-4F), in a similar way to that for the content of the boron atoms.

These results are shown in Table 37 together with the result of Comparative Example 9.

(Evaluation for Charging Ability)

A remodeled machine was used for the evaluation, which was prepared by modifying an electrophotographic apparatus iR-5065 (trade name) made by Canon Inc. so as to have a process speed of 300 mm/sec. The amount of an electric current to be applied to the main charging assembly was controlled to +1,600 μA in a state of having turned the image exposure off, the surface potential of the electrophotographic photosensitive member at the position of a developing apparatus at the central portion in the longitudinal direction of the electrophotographic photosensitive member was measured, and the value of the surface potential was determined to be the charging ability.

The evaluation result was shown by a result of a relative comparison in which the charging ability in the case of having mounted the electrophotographic photosensitive member for the film-forming condition No. 55, which had been produced in Example 8, was considered as 1.00. When being evaluated to be class (A) or (B), the charging ability was determined to be adequate.

Class (A) means that the ratio of the charging ability of the evaluated photosensitive member with respect to the charging ability of the electrophotographic photosensitive member for the film-forming condition No. 55, which was produced in Example 8, is 1.20 or more.

Class (B) means that the ratio of the charging ability of the evaluated photosensitive member with respect to the charging ability of the electrophotographic photosensitive member for the film-forming condition No. 55, which was produced in Example 8, is 0.95 or more and less than 1.20.

Class (C) means that the ratio of the charging ability of the evaluated photosensitive member with respect to the charging ability of the electrophotographic photosensitive member for the film-forming condition No. 55, which was produced in Example 8, is less than 0.95.

TABLE 34

| | Lower | | Upper | |
|---|---|---|---|---|
| | charge | | charge | |
| | injection | Photo- | injection | |
| | inhibition | conductive | inhibition | Surface |
| | layer | layer | layer | layer |
| Type of gas and flow rate | | | | |
| SiH₄ [mL/min (normal)] | 350 | 450 | * | 26 |
| H₂ [mL/min (normal)] | 750 | 2200 | | |
| PH₃ [ppm] (vs. SiH₄) | | | * | |
| B₂H₆ [ppm] (vs. SiH₄) | 1500 | 1 | | |
| NO [mL/min (normal)] | 10 | | | |
| CH₄ [mL/min (normal)] | | | * | 360 |
| Internal pressure [Pa] | 40 | 80 | 55 | 80 |
| High-frequency power [W] | 400 | 900 | * | 700 |
| Substrate temperature [° C.] | 260 | 260 | 260 | 290 |
| Film thickness [μm] | 3.3 | 25 | 0.2 | 0.5 |

TABLE 35

| Film-forming condition No. | 55 | 56 | 57 | 58 |
|---|---|---|---|---|
| SiH₄ [mL/min (normal)] | 250 | 250 | 250 | 250 |
| PH₃ [ppm] (vs. SiH₄) | 30 | 450 | 3450 | 34500 |
| CH₄ [mL/min (normal)] | 310 | 310 | 310 | 310 |
| Internal pressure [Pa] | 55 | 55 | 55 | 55 |
| High-frequency power [W] | 400 | 400 | 400 | 400 |
| Substrate temperature [° C.] | 260 | 260 | 260 | 260 |
| Film thickness [μm] | 0.2 | 0.2 | 0.2 | 0.2 |

### Comparative Example 9

Two electrophotographic photosensitive members to be positively charged were produced in the same method as in Example 8, except that the upper charge injection inhibition layer was produced on conditions shown in the following Table 36. The produced electrophotographic photosensitive members to be positively charged were evaluated in a similar way to that in Example 8. These results are shown in Table 37 together with the result of Example 8.

TABLE 36

| Film-forming condition No. | 59 | 60 |
|---|---|---|
| SiH₄ [mL/min (normal)] | 250 | 250 |
| PH₃ [ppm] (vs. SiH₄) | 15 | 40250 |
| CH₄ [mL/min (normal)] | 310 | 310 |
| Internal pressure [Pa] | 55 | 55 |
| High-frequency power [W] | 400 | 400 |
| Substrate temperature [° C.] | 260 | 260 |
| Film thickness [μm] | 0.2 | 0.2 |

TABLE 37

| | | | Durability number of sheets/A4 | | | | | |
|---|---|---|---|---|---|---|---|---|
| | | Content of | Initial stage | | 250,000 sheets | | 500,000 sheets | |
| | Film-forming | phosphorus atom | Adhesive- | Sensitivity | Adhesive- | Sensitivity | Adhesive- | Sensitivity |
| | condition No. | (atomic ppm) | ness 1 | irregularity | ness 1 | irregularity | ness 1 | irregularity |
| Com. Ex. 9 | 59 | 5 | A | A | A | A | A | A |
| Ex. 8 | 55 | 10 | A | A | A | A | A | A |
| | 56 | 150 | A | A | A | A | A | A |
| | 57 | 3000 | A | A | A | A | A | A |
| | 58 | 30000 | A | A | A | A | A | A |
| Com. Ex. 9 | 60 | 35000 | A | A | A | A | A | A |

| | Durability number of sheets/A4 | | | | | | |
|---|---|---|---|---|---|---|---|
| | 750,000 sheets | | 1,000,000 sheets | | | | |
| | Adhesive- | Sensitivity | Adhesive- | Sensitivity | Adhesive- | Gradation | Gradation |
| | ness 1 | irregularity | ness 1 | irregularity | ness 2 | properties | properties |
| Com. Ex. 9 | A | A | A | A | A | C | A |
| Ex. 8 | A | A | A | A | A | B | A |
| | A | A | A | A | A | B | A |
| | A | A | A | A | A | A | A |
| | A | A | A | A | A | A | A |
| Com. Ex. 9 | A | A | A | A | A | A | B |

* The C/(Si + C) in the upper charge injection inhibition layer was in the range of 0.30 ± 0.05.

It was found from the results of Table 37 that the charging ability and the gradation properties were adequately kept by controlling the content of phosphorus atoms which are the Group 15 atom of the Periodic Table with respect to that of the silicon atoms in the upper charge injection inhibition layer to 10 atom ppm or more and 30,000 atom ppm or less. It was also confirmed that an electrophotographic photosensitive member was obtained in which the surface deterioration was suppressed, the sensitivity irregularity was adequately kept, and was superior in the adhesiveness, the gradation properties and the charging ability.

### Example 9

An electrophotographic photosensitive member to be negatively charged was produced on a cylindrical substrate (cylindrical substrate made from aluminum, which had a diameter of 84 mm, a length of 381 mm and a thickness of 3 mm, and was mirror-finished) by using a plasma treatment apparatus which is illustrated in FIG. 2 and uses a high-frequency power source that employs RF bands as a frequency, according to the following conditions shown in Table 38. At this time, a lower charge injection inhibition layer, a photoconductive layer, an upper charge injection inhibition layer and a surface layer were formed in this order, and the total film thickness of the electrophotographic photosensitive member was controlled to the conditions shown in the following Table 39 by adjusting the film thickness conditions of the photoconductive layer. In addition, two electrophotographic photosensitive members to be negatively charged were produced for each film-forming condition. In addition, the forming condition for the surface layer is the same as the film-forming condition No. 26 in Example 4, and the surface layer to be formed has characteristics specified in the range of the present invention.

The adhesiveness, the sensitivity irregularity and the gradation properties in the produced electrophotographic photosensitive member to be negatively charged were determined in the same method as in Example 1, and the charging ability and the sensitivity were evaluated in the method which will be described below.

However, the electrophotographic apparatus which was used here was a remodeled machine which was prepared by modifying an electrophotographic apparatus iR-5065 (trade name) made by Canon Inc. so as to have a process speed of 700 mm/sec.

These evaluation results are shown in Table 40 together with the result of the film-forming condition No. 26 in Example 4.

(Evaluation for Charging Ability)

A remodeled machine was used for the evaluation, which was prepared by modifying an electrophotographic apparatus iR-5065 (trade name) made by Canon Inc. so as to have a process speed of 700 mm/sec. The amount of an electric current to be applied to the main charging assembly was controlled to −1,600 μA in a state of having turned the image exposure off, the surface potential of the electrophotographic photosensitive member at the position of a developing apparatus at the central portion in the longitudinal direction of the electrophotographic photosensitive member was measured, and the value of the surface potential was determined to be the charging ability.

The evaluation result was shown by a result of a relative comparison in which the charging ability in the case of having mounted the electrophotographic photosensitive member for the film-forming condition No. 26, which had been produced in Example 4, was considered as 1.00.

Class (AA) means that the ratio of the charging ability of the evaluated photosensitive member with respect to the charging ability of the electrophotographic photosensitive member for the film-forming condition No. 26, which was produced in Example 4, is 1.45 or more. Class (A) means that the ratio of the charging ability of the evaluated photosensitive member with respect to the charging ability of the electrophotographic photosensitive member for the film-forming condition No. 26, which was produced in Example 4, is 1.20 or more and less than 1.45.

Class (B) means that the ratio of the charging ability of the evaluated photosensitive member with respect to the charging ability of the electrophotographic photosensitive member for the film-forming condition No. 26, which was produced in Example 4, is 0.95 or more and less than 1.20.

(Evaluation for Sensitivity)

The same evaluation machine as in the evaluation for charging ability was used for the evaluation.

The produced electrophotographic photosensitive member was mounted in the electrophotographic apparatus, and the amount of the electric current to be supplied to the main charging assembly was controlled in a state of having turned the image-exposing light off so that the surface potential of the electrophotographic photosensitive member could be −500 V at the position of a developing apparatus at the center position in the longitudinal direction of the electrophotographic photosensitive member. After that, the image-exposing light was emitted, and the light quantity of the light source for the image exposure was controlled so that the surface potential of the electrophotographic photosensitive member at the position of the developing apparatus could be −100 V. The sensitivity was evaluated with the use of the light quantity of the image-exposing light set at that time.

The light source for the image-exposure for the electrophotographic apparatus which was used for the evaluation of the sensitivity was a semiconductor laser having the oscillation wavelength of 658 nm.

The evaluation result was shown by a result of a relative comparison in which the light quantity of the image-exposing light in the case of having mounted the electrophotographic photosensitive member for the film-forming condition, No. 26 which had been produced in Example 4, was considered as 1.00.

Class (AA) means that the ratio of the light quantity of the image-exposing light with respect to the light quantity of the image-exposing light of the electrophotographic photosensitive member for the film-forming condition No. 26, which was produced in Example 4, is less than 0.80.

Class (A) means that the ratio of the light quantity of the image-exposing light with respect to the light quantity of the image-exposing light of the electrophotographic photosensitive member for the film-forming condition No. 26, which was produced in Example 4, is 0.80 or more and less than 0.90.

Class (B) means that the ratio of the light quantity of the image-exposing light with respect to the light quantity of the image-exposing light of the electrophotographic photosensitive member for the film-forming condition No. 26, which was produced in Example 4, is 0.90 or more.

TABLE 38

| | Lower | | Upper | |
|---|---|---|---|---|
| | charge | | charge | |
| | injection | Photo- | injection | |
| | inhibition | conductive | inhibition | Surface |
| | layer | layer | layer | layer |
| Type of gas and flow rate | | | | |
| SiH₄ [mL/min (normal)] | 350 | 450 | 250 | 26 |
| H₂ [mL/min (normal)] | 750 | 2200 | | |
| PH₃ [ppm] (vs. SiH₄) | 1500 | | | |
| B₂H₆ [ppm] (vs. SiH₄) | | | 900 | |
| NO [mL/min (normal)] | 10 | | | |
| CH₄ [mL/min (normal)] | | | 310 | 150 |
| Internal pressure [Pa] | 40 | 80 | 55 | 80 |
| High-frequency power [W] | 400 | 900 | 400 | 850 |
| Substrate temperature [° C.] | 260 | 260 | 260 | 290 |
| Film thickness [μm] | 3.3 | * | 0.2 | 0.5 |

TABLE 39

| Film-forming condition No. | 61 | 62 | 63 | 64 | 65 |
|---|---|---|---|---|---|
| Film thickness of photoconductive layer [μm] | 26 | 36 | 56 | 76 | 86 |
| Total film thickness of electrophotographic | 30 | 40 | 60 | 80 | 90 |
| photosensitive member [μm] | | | | | |

TABLE 40

| | | | Durability number of sheets/A4 | | | | | |
|---|---|---|---|---|---|---|---|---|
| | | Total film | Initial stage | | 250,000 sheets | | 500,000 sheets | |
| | Film-forming | thickness | Adhesive- | Sensitivity | Adhesive- | Sensitivity | Adhesive- | Sensitivity |
| | condition No. | (μm) | ness 1 | irregularity | ness 1 | irregularity | ness 1 | irregularity |
| Ex. 4 | 26 | 25 | A | A | A | A | A | A |
| Ex. 9 | 61 | 30 | A | A | A | A | A | A |
| | 62 | 40 | A | A | A | A | A | A |
| | 63 | 60 | A | A | A | A | A | A |
| | 64 | 80 | A | A | A | A | A | A |
| | 65 | 90 | A | A | A | A | A | A |

| | Durability number of sheets/A4 | | | | | | |
|---|---|---|---|---|---|---|---|
| | 750,000 sheets | | 1,000,000 sheets | | | | |
| | Adhesive- | Sensitivity | Adhesive- | Sensitivity | Gradation | | Gradation |
| | ness 1 | irregularity | ness 1 | irregularity | properties | Sensitivity | properties |
| Ex. 4 | A | A | A | A | B | B | A |
| Ex. 9 | A | A | A | A | B | A | A |
| | A | A | A | A | A | AA | A |
| | A | A | A | A | AA | AA | A |
| | A | A | A | A | AA | AA | A |
| | A | A | A | A | AA | AA | A |

It was found from the results of Table 40 that such an electrophotographic photosensitive member was obtained as to be particularly superior in the charging ability and the sensitivity, and be superior in the adhesiveness, the sensitivity irregularity and the gradation properties even when having been used in a high-speed process, by controlling the total film thickness of the electrophotographic photosensitive member to 40 m or more. When the total film thickness of the electrophotographic photosensitive member was controlled to 90 μm, image defects occasionally increased because an abnormal growth portion of the film largely grew.

This application claims the benefit of Japanese Patent Applications No. 2009-298072, filed Dec. 28, 2009, and No. 2010-277782, filed Dec. 14, 2010 which are hereby incorporated by reference herein in their entirety.

1. An electrophotographic photosensitive member comprising a conductive substrate, a lower charge injection inhibition layer formed from amorphous silicon on the conductive substrate, a photoconductive layer formed from amorphous silicon on the lower charge injection inhibition layer, an upper charge injection inhibition layer formed from hydrogenated amorphous silicon carbide on the photoconductive layer, and a surface layer formed from hydrogenated amorphous silicon carbide on the upper charge injection inhibition layer, wherein
the upper charge injection inhibition layer contains 10 atom ppm or more and 30,000 atom ppm or less of Group 13 atoms or Group 15 atoms of the Periodic Table with respect to silicon atoms in the upper charge injection inhibition layer, and
a ratio (C/(Si+C)) of a number (C) of carbon atoms in the upper charge injection inhibition layer to a sum of a number (Si) of silicon atoms and the number (C) of the carbon atoms in the upper charge injection inhibition layer is 0.10 or more and 0.60 or less; and
a sum of an atom density of the silicon atoms and an atom density of the carbon atoms in the surface layer is 6.60×10²² atoms/cm³ or more, and
the ratio (C/(Si+C)) of the number (C) of the carbon atoms in the surface layer to the sum of the number (Si) of the silicon atoms and the number (C) of the carbon atoms in the surface layer is 0.61 or more and 0.75 or less.

2. The electrophotographic photosensitive member according to claim 1, wherein a ratio (H/(Si+C+H)) of a number (H) of hydrogen atoms in the surface layer to the sum of the number (Si) of silicon atoms, the number (C) of carbon atoms and the number (H) of the hydrogen atoms in the surface layer is 0.30 or more and 0.45 or less.

3. The electrophotographic photosensitive member according to claim 1, wherein the sum of the atom density of the silicon atoms and the atom density of the carbon atoms in the surface layer is 6.81×10²² atoms/cm³ or more.

4. The electrophotographic photosensitive member according to claim 1, wherein a ratio (ID/IG) of a peak intensity (ID) of 1390 cm⁻¹ to a peak intensity (IG) of 1480 cm⁻¹ in a Raman spectrum of the surface layer is 0.20 or more and 0.70 or less.

5. The electrophotographic photosensitive member according to claim 1, wherein a total film thickness of all layers formed on the conductive substrate is 40 μm or more and 80 μm or less.

6. An electrophotographic apparatus comprising the electrophotographic photosensitive member according to claim 1, and a charging unit, an image-exposing unit, a developing unit and a transferring unit.
